(19) United States
(12) Patent Application Publication
(10) Pub. No.: US 2016/0239620 A1
(43) Pub. Date: Aug. 18, 2016

(54) SYSTEM AND METHOD OF PREDICTING PERSONAL THERAPEUTIC RESPONSE

(71) Applicants: Yves André LUSSIER, Tucson, AZ (US); Vincent GARDEUX, Tucson, AZ (US); Ikbel ACHOUR, Tucson, AZ (US); THE BOARD OF TRUSTEES OF THE UNIVERSITY OF ILLINOIS, Urbana, IL (US)

(72) Inventors: Yves André LUSSIER, Tucson, AZ (US); Vincent GARDEUX, Tucson, AZ (US); Ikbel ACHOUR, Tucson, AZ (US)

(21) Appl. No.: 15/026,884

(22) PCT Filed: Oct. 2, 2014
(86) PCT No.: PCT/US2014/058924

§ 371 Date: Apr. 1, 2016

Related U.S. Application Data
(60) Provisional application No. 61/886,456, filed on Oct. 3, 2013.

(51) Int. Cl. G06F 19/00; G06F 19/20; G06N 7/00

(52) U.S. Cl. CPC G06F 19/345; G06N 7/005; G06F 19/20

(57) ABSTRACT

A system and method of predicting the course of progression of a disease and determining a personalized therapeutic regime for treating the disease in a subject includes obtaining the subject's normal-tissue transcriptome. The normal-tissue transcriptome is statistically correlated with the subject's perturbed transcriptome to identify one or more deregulated mechanisms; and statistics derived from the identified deregulated mechanism are used to predict the course of progression of the disease and to a recommend a personalized therapeutic regime for treating the disease. The perturbed transcriptome may in some cases be determined from a cancer of the subject, and in other cases from viral infected tissue cultured from the subject.

### RELATED APPLICATIONS AND PRIORITY CLAIM

The present document claims priority to U.S. Provisional Patent Application 61/886,456, entitled Method of Predicting Personal Therapeutic Response, filed 3 Oct. 2013.

### GOVERNMENT RIGHTS CLAUSE

The present invention has been supported by The National Library of Medicine, grant number K22 LM008308-04. The Government has certain rights in the invention.

### TECHNICAL FIELD

This invention is a method of individualized diagnosis, prognosis, and patient treatment based on statistical analysis of patient's normal and diseased-tissue transcriptomes.

### BACKGROUND

The expression of genes and regulatory transcripts encoded within DNA is the primary mechanism regulating cellular metabolism. Transcription and the post-transcriptional processing of RNA sets the framework for all phases of cellular function. For proteins that control essential cellular functions, such as replication and differentiation, the levels of RNA expression and protein synthesis are tightly correlated. Changes within the environment of a cell or tissue often result in necessary alterations in cellular functions. For example, a cell may alter the pattern of gene expression in response to environmental factors, such as ligand and metabolite stimulated signaling. Furthermore, cellular expression of RNA and proteins may be altered intentionally as with the use of some therapeutic drugs. These changes in gene expression may be due to both the beneficial and the toxic effects of these drugs. Alterations in gene expression in both the normal or diseased state can be utilized for determining the efficacy and mechanisms of action of potential treatments. In the case of oncogenic transformation, cells may exhibit subtle changes in expression during cancer progression. Changes in gene expression of key proteins involved in cellular transformation have the potential to be used as predictive markers of oncogenesis. The sequencing and mapping of the human genome has resulted in a database of potentially expressed genes. Several tools, including high-density micro-arrays have been developed to measure the expression of each of these genes, including potential splice variants.

The emergence of precision medicine ushered in a groundbreaking era in medicine with the opportunity to incorporate individual molecular data into patient care. The variability of individual patients at the molecular level leads to the requirement of individual mechanistic classifiers for accurate prognosis and drug response. However, this individual based-approach requires specific robust statistics, in order to unveil deregulated mechanisms at the level of the single patient, tissue, or cell lines paired samples. Gene expression profile analysis commonly requires a large sample size to achieve sufficient statistical power to uncover deregulated genes or pathways. Yet, such analysis highlights common pathways extrapolated to larger population, and overlooks the differences between samples to detect specific individual response to therapy or tissue specific-dependent mechanisms. Therefore, methods are required to empower mechanism-level analysis on a single pairs of samples (tumor vs matched control, primary tumor vs metastases, before vs after treatment samples, etc.).

Single-subject design also referred to as, N-of-1 clinical trial was first introduced by R. A. Fisher in 1945. This type of study aims to extract information from the pattern of variation of one or several observed variables over time, derived from a single sample (patient, cell, etc.) N-of-1 clinical trials (or single-subject design) measure patient disease progression or treatment efficacy over time. Despite its longstanding foundation, N-of-1 trials rely on time series analyses (≧3 patients) and remains underpowered for genomics studies.

The advent of the increased dynamic range and accuracy of RNA-sequencing over expression arrays provides an unparalleled opportunity for studying single subject transcriptomes. Further, 99% of molecular biomarkers derived from large patient samples predictors fail to be reproducible. While molecular biomarker discovery in N-of-1 studies may appear unfeasible, we and others have recently shown that highly reproducible multi-gene biomarkers can be directly calculated from these cohorts using mechanisms-associated genesets leveraged from transcriptomes as measured by expression arrays or RNA-Seq. Moreover, these geneset-classifiers outperform gene-level classifiers and provide biological context, in addition to calculate geneset scores on each sample. However, they require a comparison of at least 3 samples and two groups to generate p-values.

Understanding individual patient host-response to viruses is key to designing optimal personalized therapy. Unsurprisingly, in vivo human experimentation to understand individualized dynamic response of the transcriptome to viruses are rarely studied because of the obviously limitations stemming from ethical considerations of the clinical risk.

### SUMMARY

Our method reformulates the problem of identifying deregulated mechanisms across patients (“population-based”) into a statistic pertaining to each individual patient. We have shown that we can improve these previously described geneset-level methodologies in paired sample analyses, thus enabling N-of-1 trials with two paired samples.

The method of the invention, N-of-1-pathways, is able to uncover deregulated pathways at the single patient level, and highlight both individuality and commonality of patient trait or tissue specific associated-pathways. It is the first method that offers the opportunity to leverage individual molecular data for improved diagnosis, prognosis, and patient treatment.

N-of-1-pathways relies on three main concepts, which balance statistics, biological modules and information theory: i) a single paired sample is considered the “entire statistical universe”, and its genes are the “statistical population” under study (within sample statistic); ii) expressions of multiple genes are combined, into genesets as a proxy for biological modules or “pathway” functions; iii) p-values generated for each pathway-associated geneset are sample specific. Hence, in order to conduct cross-studies analyses, semantic similarity metric has been used to reduce the dimensionality of the resulting pathways. Information theory similarity score takes into account inter-mechanisms' relationships, and allows for an unbiased assessment of similarity of pathways conveying the same biologic signal within-sample, cross-samples and across predictions. An unbiased metric of relatedness is crucial as curated hierarchies of classifications and ontologies are arbitrary and inaccurate in assessing relations between genesets. We finally assess common and patient- or sample-specific deregulated mechanisms found by N-of-1-pathways, GSEA and DEG enrichment across studies. Taken together, this new method offers opportunity to enhance the underpinning biology across cell/tissue types and between human and animal models.

Accordingly, this invention includes predicting the course of progression of a disease and a personalized therapeutic regime for treating the disease in a subject including: (i) obtaining the subject's normal tissue and diseased tissue transcriptomes; (ii) statistically correlating the transcriptomes to identify one or more deregulated mechanisms; and (iii) using the identified deregulated mechanisms to predict the course of progression of a disease and devise a personalized therapeutic regime for treating the disease.

In certain embodiments, the subject's diseased-tissue or perturbed transcriptome and the subject's normal-tissue transcriptome are correlated with the corresponding transcriptome of one or more additional subjects.

In certain other embodiments, the transcriptomes are measured by expression arrays or RNA-sequencing. In certain other embodiments, the transcriptomes are measured by performing RT-PCR to produce DNA associated with expressed genes, and then analyzing the resulting DNA.

In certain other embodiments, the subject's transcriptome is selected from the subject's disease transcriptome and the subject's normal-tissue transcriptome.

Additional non-limiting features, embodiments and aspects of the invention are described in the following Figures and Detailed Description.

### BRIEF DESCRIPTION OF THE FIGURES

FIG. 1 is a block diagram of a system embodying the present invention

FIG. 2 is a flowchart of an analysis embodying the present invention.

FIG. 2A is a flow diagram of the N-of-1 pathways method.

FIG. 2B is an illustration of 3 principles of the N-of-1 pathways method described herein.

FIG. 3. Synthetic data: Evaluation of size and ratio of concordant deregulated genes within a pathway found deregulated in the N-of-1-pathways statistical analysis component.

FIG. 4A Concordant deregulated pathways (genesets) uncovered by N-of-1-pathways, ssGSEA, DEG Enrichment, and GSEA methods within the exploration dataset (internal validation); with precision-recall curves based on the perfect GO overlap (Panel A).

FIG. 4B Concordant deregulated pathways (genesets) uncovered by N-of-1-pathways, ssGSEA, DEG Enrichment, and GSEA methods within the exploration dataset (internal validation); with GO semantic similarity overlap GO-ITS≧0.7; using GSEA; the Proxy Gold Standard (GS).

FIG. 5A illustrates the overlap of deregulated GO-BP terms associated-pathways between the three external validation studies I, II and III of lung adenocarcinoma.

FIG. 5B illustrates PPV (Positive Predictive Value) determined using concordant deregulated pathways between exploration and external validation studies using pathways reported in study I.

FIGS. 5C and 5E, Precision-recall curves of concordant deregulated pathways between exploration and external validation studies using GSEA.

FIGS. 5D and 5F Precision-recall curves of concordant deregulated pathways between exploration and external validation studies using DEG Enrichment as a “Proxy Gold Standard”.

FIG. 6A Is an illustration of individuality and commonality of the deregulated mechanisms from the exploration dataset, showing a heatmap generated by the list of Z-Scores for each patient (in rows) and each GO-BP Term found significantly deregulated in at least one patient over 55 (in columns). Below the heatmap, three sub-panels show additional details for each GO-BP Term: (i) the number of patient sharing the given pathway (patient count), (ii) the curated categorization of the GO-BP Terms into 10 classes, and (iii) the similarity with the external Gold Standard.

FIG. 6B Illustrates a Kaplan-Meier survival curve of the three PAM clusters derived from GO-BP Z-score without clinical information, as illustrated in FIG. 6A.

FIGS. 6C and 6D, show the clustering of distinct patients according to the two Principal Components of individual GO-BPs performed on the exploration set. “*”=p-value to a t-test <0.05, of the patients whose data is illustrated in FIG. 6A.

FIG. 7A shows a global comparison of 55 patients results taken together. Comparison of the GO-BPs predicted by N-of-1-pathways in the exploration dataset and their similarity to those of the External Gold Standard

FIG. 7B shows, for each patient, the level of similarity of individual deregulated mechanisms with the External GS (ratio).

FIG. 8 is a flow diagram of samples and sequencing operations performed in Example 2.

FIG. 9 illustrates Example 2's WITHIN-STUDY concordance of PTBP1-KD associated mechanisms unveiled by N-of-1-pathways and DEG Enrichment in RNA-Seq neuronal cell line (Dataset I). Each Venn diagram corresponds to the overlap of deregulated mechanisms, GO-BP terms (left panel) and KEGG pathways (right panel) found between N-of-1-pathways (at different cutoff, Bonf.≦1%, Bonf.≦5% and FDR≦5%) and DEG Enrichment method (FDR≦5%). The Odds Ratios (OR) and p-values are shown below each Venn diagram. GSEA is not represented as it cannot be computed with a single paired sample.

FIG. 10 illustrate within Example-2's studies Information Theoretic Similarity (ITS), applicable for GO-BP mechanisms, of the Within-Study Proxy Gold Standard co compare N-of-1 results, GSEA and DEG-Enrichment, with precision-recall curves.

FIG. 11 illustrates across Example-2's studies' ITS similarity for GO-BP of the Cross-Studies derived Gold Standards of PTBP1-depleted results, with precision-recall curves.

FIG. 12 illustrates Example 2's Cross-studies results, comparing tissue-specific and concordance of mechanisms regulated by PTBP1 unveiled by N-of-1-pathways, DEG Enrichment and GSEA across all three studies.

FIG. 13A shows 272 terms of the 399 deregulated pathways found using GSEA method are similar to the full list of pathways unveiled by the DEG+Enrichment method in the ex vivo dataset (ITS cutoff ≧0.7. Similarity Odds Ratio≈29, p<10-100; showing robustness of pathways in two datasets.

FIG. 13B: Similarity Odds Ratio≈9.5, p=1.2×10-31, also showing robustness of pathways enriched separately in the two datasets is confirmed by consistency of GSEA and DEG+Enrichment.

FIG. 14A shows the overlap between the ex vivo and in vivo human studies of deregulated genes found using SAMR method (Methods: DEG calculation). Since the two studies used different microarray chips, we showed in parenthesis the number of deregulated genes that can be found in the common background of both chips (common background=12819 genes). The overlap is very significant (Fisher's Exact Test p=3.41E-25; Odds Ratio=5.226.

FIG. 14B shows the GO-BP terms that are overlapping or similar across both datasets by two different techniques: GSEA and DEG+Enrichment, using two Similarity Venn Diagrams, the left one representing the overlap and similarity between the GO-BP terms unveiled by GSEA across the two studies, and the right one representing the same information, but when applying the DEG+Enrichment method.

FIG. 15 illustrates the 56 GO-BP Terms found deregulated by the GSEA method as a network across the two studies (in vivo and ex vivo), displayed in FIGS. 13 and 14 with reference to Example 3.

FIG. 16 illustrates ROC curves showing the robustness of N-of-1-pathways predictions in each ex vivo infected PBMC confirmed by an in vivo human infection study; these curves are calculated by similarity to a Proxy Gold Standard (Methods).

FIG. 17A, illustrates a Principal Component Analysis of N-of-1-Pathways Scores discriminates asymptotic patients from symptomatic infected patients in vivo (PBMC expression) for rhinovirus.

FIG. 17B illustrates a Principal Component Analysis of N-of-1-Pathways Scores discriminates asymptotic patients from symptomatic infected patients in vivo (PBMC expression) for.

### DETAILED DESCRIPTION OF THE EMBODIMENTS

This invention includes a method of translating individualized transcriptome profiles into mechanism-level profiles on single pairs of samples (one p-value per geneset). It relies on three principles: i) the statistical universe is a single paired sample, which serves as its own control; ii) statistics can be derived from multiple gene expression measures that share common biological mechanisms assimilated to genesets; and iii) semantic similarity metric takes into account inter-mechanisms' relationships to better assess commonality and differences, within and across study-samples (e.g. patients, cell-lines, tissues, etc.), which helps the interpretation of the underpinning biology. This permits individualized predictions of disease prognosis, clinical trial response and the design of individualized therapies from among existing therapeutic protocols.

As used herein, “transcriptome” means the set of all RNA molecules, including mRNA, rRNA, tRNA and other non-coding RNA produced in one or a population of cells. The term can be applied to the total set of transcripts in a given organism, or to the specific subset of transcripts present in a particular cell type. Because it includes all mRNA transcripts in the cell, the transcriptome reflects the genes that are being expressed at any given time. The study of transcriptomics, also referred to as expression profiling, examines the expression level of mRNAs in a given cell population and time, often using high-throughput techniques based on DNA microarray technology and/or RNA-sequencing (RNA-seq). RNA-seq is based on next-generation sequencing technology to study the transcriptome at the nucleotide level and it is emerging as a method of choice for measuring transcriptomes of organisms, though the older technique of DNA microarrays is still used.

As discussed herein, this invention may be used to more accurately determine the proper course of treatment of a disease or disorder in an individual patient so that the patient is neither under nor over treated or subjected to inappropriate or ineffective treatments

“Treating” a mammal having a disease or disorder means accomplishing one or more of the following: (a) reducing the severity of the disease; (b) arresting the development of the disease or disorder; (c) inhibiting worsening of the disease or disorder; (d) limiting or preventing recurrence of the disease or disorder in patients that have previously had the disease or disorder; (e) causing regression of the disease or disorder; (f) improving or eliminating the symptoms of the disease or disorder; and (g) improving survival. Treating may comprise surgery, administering to the patient a therapeutically-effective amount of one or more drugs and/or behavior modifications such as exercise and diet modification. The aforementioned treatment or combination of treatments may also be referred to herein as a “therapeutic regime” or “course of treatment”.

In certain embodiments, the disease or disorder is cancer or neurodegenerative disease. In other embodiments, the disease or disorder is an immune-related disease such as an autoimmune disease, and in other embodiments the disease is a viral disease. In particular embodiments the disease or disorder is Alzheimer's disease or lung, breast or ovarian cancer.

The method 200 is performed using a system 100 that takes two culture plates, a “normal” cell sample or unperturbed cell culture plate 102, and a “perturbed” cell sample or culture plate 104. In particular embodiments, the normal sample is derived from the healthy tissue proximal to cancerous tumor tissues from the same subject. The perturbed sample or cultured plate 104 is a sample of the cancerous tumor tissue or cells derived from the same subject. In other embodiments, the perturbed plate 104 is a sample of tissue that has been taken 202, cultured 204, and infected 106 or perturbed 206 with a virus, while the normal or unperturbed 208 culture plate 102 is a similar sample that has been cultured without infection. Both plates are submitted to ribose nucleic acid (RNA) extraction 106, 108, 210, 212.

In embodiments, extracted unperturbed RNA is then amplified and probed 214 using a microchannel RNA analysis plate 110 having, in a particular embodiment, approximately 50,000 probes, and read 216 using a microplate reader 114. Similarly, extracted perturbed RNA is then amplified, probed 218, and read 220 using a similar RNA analysis plate 112 and reader 114. In an alternative embodiment, unperturbed RNA is sequenced 222 and quantified, and perturbed RNA is sequenced 224 and quantified using an RNA sequencer as known in the art of molecular biology. In yet another alternative embodiment, unperturbed RNA is examined by RT-PCR amplified and converted to DNA (known as cDNA as it is complimentary to the initial RNA) using RT-PCR (Reverse-transcriptase polymerase chain reaction) 223 and a conventional DNA analysis system such as a DNA sequencer or DNA microplate, and perturbed RNA is amplified and converted to DNA using RT-PCR 225 and a similar DNA analysis system, Any other RNA transcription-level analysis method, such as real-time qPCR, may also be used. Microplate readings, or RNA sequences, are then read into a processor 116. The readings are then normalized 230 by a normalization routine 118 in memory 120 executed by processor 116. The quantified, normalized, microplate readings or sequences are then sorted or classified 232 into genetic and metabolic pathways according to a Gene Ontology database by a gene pathway classifier 122 in memory 120; RNA readings not associated with a pathway are discarded. In alternative embodiments, such as Example 2, The Kyoto Encyclopedia of Genes and Genomes (KEGG) is used as a genetic knowledge database. Next, a control-perturbed comparator 124 in memory 120 executes to compare 234 the perturbed and unperturbed readings. Compared readings are then filtered 236 by executing filters routines 126 to determine a subset of pathways that have become deregulated in the perturbed sample by more than plus or minus 5 percent, and have between 5 and 500 genes in the pathway, remaining RNA results are discarded. In alternative embodiments, as in Example 2, other numbers of genes in a pathway are used for filtering, such as 15 to 500. Then statistics on the deregulated pathways are computed 238 by statistics generator 128 routines. Finally, the statistics are analyzed by treatment and prognosis analyzer 130 routines in memory 120 executing on processor 116 to provide 240 a prognosis and treatment recommendation, and prognosis and recommendations are displayed 242 on a monitor 132.

Pathways identified by the gene path classifier are defined by the collaboration and/or the flow of events of a set of genes or genesets (gene products). They can be derived from “canonical” curated pathways using knowledge base of gene annotations such as Gene Ontology (GO), KEGG or any knowledge base that define and collect information about gene functions and corresponding pathways. It could be also collected from annotations based on co-mRNA or co-expression networks or patterns (often referred as co-expression modules). Pathways can be assimilated to genesets, mechanisms or processes.

For example, GO, Gene Ontology: is a database resource that provides a controlled vocabulary and an ontology of defined terms representing gene product properties. The ontology covers three domains: i) cellular component (the parts of a cell or its extracellular environment); molecular function (elemental activities of a gene product at the molecular level, such as binding or catalysis;); and biological process (operations or sets of molecular events with a defined beginning and end such as regulation of lipid; receptor internalization.)

KEGG: Kyoto Encyclopedia of Genes and Genomes, is a database resource for understanding high-level functions and utilities of the biological system, such as the cell, the organism and the ecosystem, from molecular-level information, especially large-scale molecular datasets generated by genome sequencing and other high-throughput experimental technologies

The foregoing and other aspects and advantages of the invention will appear from the following Examples and accompanying description and figures. The Examples do not necessarily represent the full scope of the invention, however, and reference is made therefore to the claims and herein for interpreting the scope of the invention.

### Example 1

We conducted this proof of concept study using a set of patients with lung adenocarcinoma published in The Cancer Genome Atlas (TCGA). Classification and treatment of this cancer remains a challenge as less than 20% of patients with stages III and above survive more than 5 years.

### Methods

Dataset and Preprocessing.

Four datasets pertaining to normal and lung adenocarcinoma were used: one exploration dataset and three external validation datasets (Table 1). The exploration dataset consists of normalized RSEM (RNA-Seq by Expectation Maximization) gene expression profiles for 55 paired normal and tumor samples (downloaded 03/2013). All measurements were log 2 transformed. If several alternative transcripts referring to the same HGNC gene name were present, only the one with maximum expression was considered for further analysis. In our efforts to minimally transform or bias the data, we processed all the experiments without filtering out low expressed genes. The three external validation datasets were derived from microarray expression profiles (Table 1), and only reported deregulated pathways or differentially expressed gene lists were used in our studies.

Gene Ontology Annotations of Biological Processes (GO-BP)

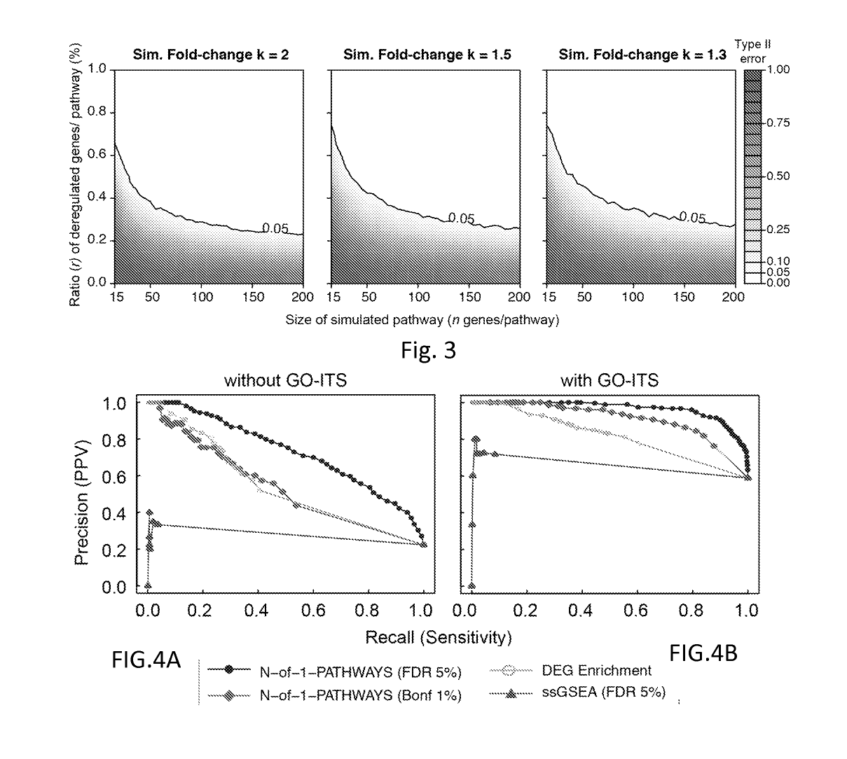

We aggregated genes into pathway-level mechanisms using Gene Ontology Biological Process, GO-BP. Hierarchical GO terms were retrieved using the org.Hs.eg.db package of Bioconductor, available for R statistical software. We used the org.Hs.egGO2ALLEGS database (downloaded on Mar. 15, 2013), which contains a list of genes annotated to that GO term (geneset) along with all of its child nodes according the hierarchical ontology structure. As stated in FIG. 3, the genesets were filtered so that only those sizes between 15 and 500 are kept in the studies. These GO annotations were used for three types of GO prioritization analyses: GSEA, DEG-Enrichment and N-of-1-pathways analysis.

N-of-1-Pathways Method.

WITHIN-PATIENT ANALYSES: The N-of-1-pathways method was performed on the exploration dataset independently for each patient, using two samples: normal and paired tumor gene expression profiles. The proposed method consists of a non-parametric paired Wilcoxon test (Wilcoxon signed-rank test) performed within each patient on the paired gene expression profiles restricted to a given pathway. Wilcoxon statistics, W⁺ and W⁻, provide direction on deregulated gene sets as overall “up-regulated” or “down-regulated” respectively. Both FDR and Bonferroni (Bonf.) corrections were applied to adjust p-values for multiple comparisons. In each paired sample, only deregulated pathways with adjusted p-values with FDR≦5% and Bonf.≦1% were retained for further analysis. CROSS PATIENTS ANALYSES: Each GO-BP mechanism has an associated FDR for each patient. The GO-BPs were then ranked according to the total number of patients sharing a given GO-term that reached significance at FDR≦5%. The prioritized GO-BP terms were listed from the most commonly to the least observed in lung adenocarcinoma patients, yet significant in at least one patient. The N-of-1-pathways software is available in R and Java at https://Lussierlab.org/N-of-1-pathways.

TABLE 1
Dataset description.

| | | Exploration | External validation | | |
|---|---|---|---|---|---|
| Dataset | | Study | Study I | Study II | Study III |
| References | Authors | NA | Yap Y et al. | Xi L et al. | Kim I et al. |
| | Source | TCGA | N.A.R. | N.A.R. | Nature Com. |
| | Date | Download 03- | 2005 | 2008 | 2013 |
| Gene | Type | RNAsea | Microarray | Microarray | Beadchip |
| expression | Platform | Illumma | Affymetrix | HuEx-1_0-st | Illumina human |
| profile | | RNAseq.v2 | HG-U133A | 6 v2.0 | |
| Gene measured | | 20502 | 22283 | 17800 | NA |
| Deregulated genes | | NA | 3442¹ | 2369 | 804 |
| Provided GO-terms | | NA | 67 | NA | NA |
| Patients | Total | 110 | 58 | 40 | 184 |
| | Normal | 55^{P} | 9 | 20^{P} | 92^{P} |
| | Tumor | 55^{P} | 49 | 20^{P} | 92^{P} |
| | Men | 22 (40%) | 32 (55.2%)* | 14 (35%) | NA |
| | Women | 32 (58.2 %) | 17 (29.3%)* | 22 (55%) | NA |
| Age | Median | 66 | 61 | 69 | NA |
| | Range | 42-86 | 38-81 | 42-86 | NA |
| Disease | I | 28 (50.9%) | 25 (43.1%) | 23 (57.5%) | NA |
| Stages | II | 14 (25.5%) | 8 (13.8%) | 5 (12.5%) | NA |
| | III | 11 (20%) | 14 (24.1%) | 7 (17.5%) | NA |
| | IV | 1 (1.8%) | 2 (3.4%) | 1 (2.5%) | NA |

*Indicates significantly different from the exploration study (FET p-value ≦ 0.05).
^{P}Indicates paired samples derived from lung tumor tissues with matched normal lung tissues.
¹and NA Indicate data not available.

Theoretical Results: Validation Using Synthetic Data (FIG. 3).

Synthetic geneset that contain a percentage of concordant deregulated genes was generated using the exploration dataset. Each point of FIG. 3 represents one geneset size of a simulated pathway varying from 15 to 500 genes by increments of 5 and generated by randomly selecting “n” genes among the 20,502 reported in the exploration study. Further, a gene subset of this synthetic geneset (ratio represented in %) “r” is considered deregulated within the pathway and varies from 5% to 100% by increments of 5%. The expression of genes included in that ratio r is artificially increased by a 2-fold change from normal to tumoral in the simulated pathway. For each pair (n, r), we then applied the N-of-1-pathways model 1,000 times to compute an empirical p-value via resampling of gene expression. This is repeated for 1,960 combinations of n and r. The unadjusted p-values reported in FIG. 3 are computed as the number of time the truly deregulated pathway of the simulation is not found deregulated (false negative) divided by 1,000.

Gene Sets Enrichment Analysis of GO-BP (GSEA).

Gene set enrichment analysis between normal and tumor samples was conducted on the exploration dataset as well as on the external validation datasets (studies II & III) using GSEA v2.0.10 software. The default parameters were used, except the permutation parameter selection, which was set to “gene_set” instead of “phenotype”. Gene set permutation was chosen to achieve enough statistical power for permutation resampling due to the small number of samples.

Differentially Expressed Genes Enriched in GO-BP (DEG-Enrichment).

Enrichments of GO-BP genesets with differentially expressed genes (DEG) were conducted in the R statistical software using the Fisher's Exact Test (FET) based on the following contingency table: (DE genes, all genes)×(In Pathway, Not in Pathway). Adjustment for multiple comparisons was performed using FDR, and pathways with FDR≦5% were considered significantly enriched. Up-regulated and down-regulated genes were enriched independently. DEGs were available from validation studies II and III except for study I for which neither the dataset nor DEGs were available. DEG of the exploration dataset was calculated in the following way: (i) genes whose average expression differs by at least a factor of four between normal and tumor samples were selected for analysis, (ii) then a non-parametric Wilcoxon test was applied between the two groups, and p-values were adjusted with Benjamini and Hochberg method (False Discovery Rate; FDR). Only DE genes with FDR≦5% were retained.

Proxy Gold Standard for the Internal Validation (FIG. 4).

Here, GO-BPs are statistically prioritized in the exploration dataset (Table 1) by three above-mentioned methods: two established ones (GSEA and DEG-Enrichment) and the new (N-of-1-pathways). Thus, the accuracy of the N-of-1-pathways is compared to one conventional method (e.g. DEG Enrichment) while the other serves as a proxy-gold standard (GSEA).

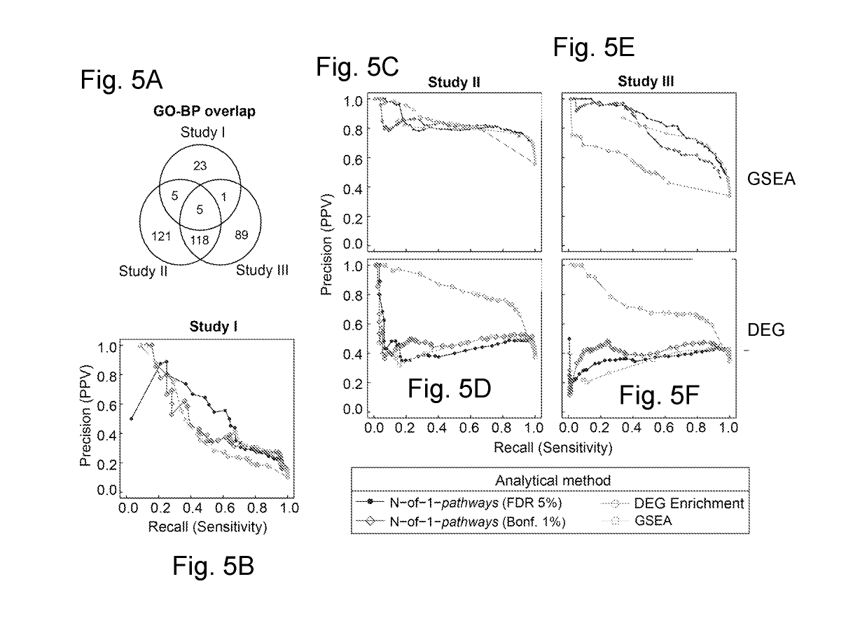

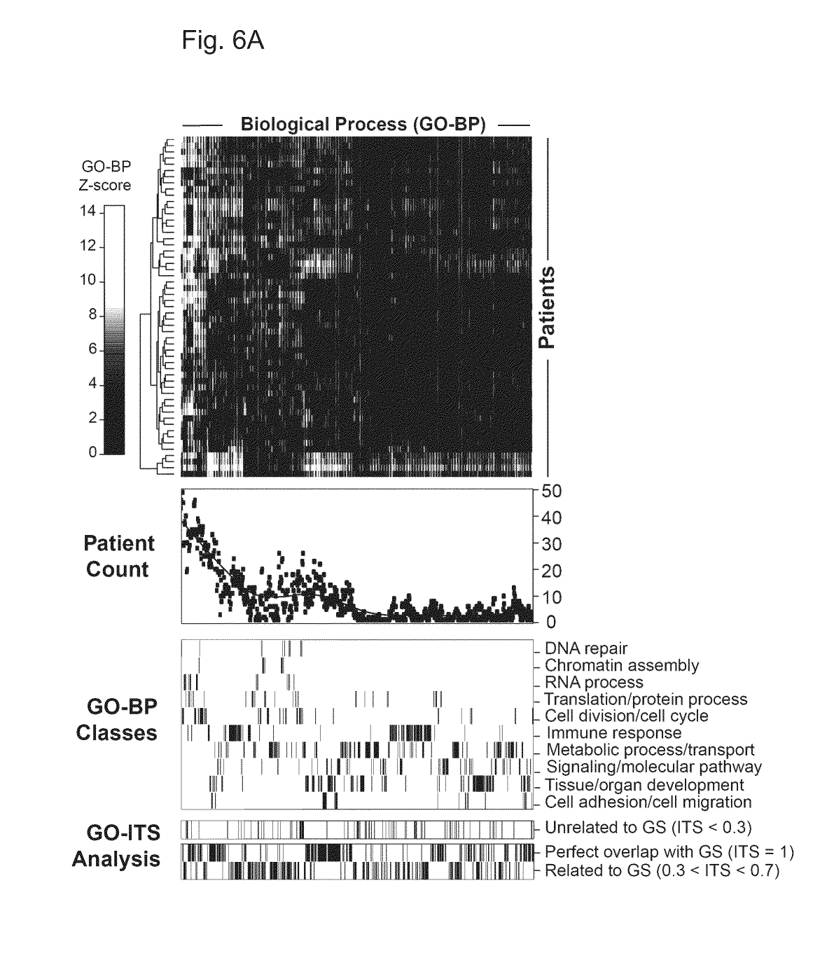

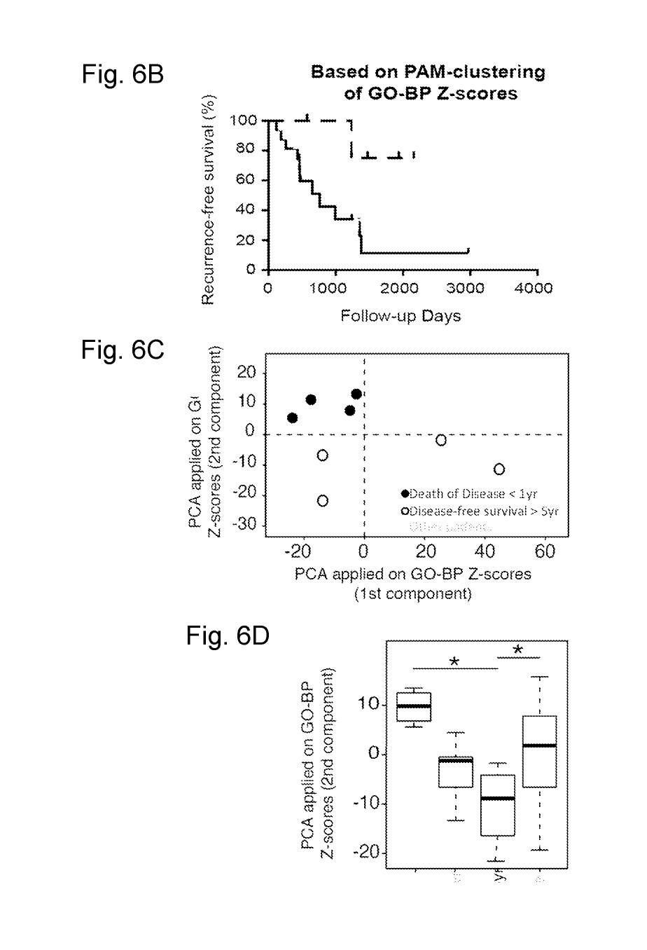

Gold Standard Derived from the External Validation Studies (FIGS. 5-6).

Significant GO-BPs published in the External validation study I were utilized as the authors did not provide an original expression dataset from which we could directly compute these results. For external validation studies II and III, significant GO-BPs were successively calculated by two previously described methods: GSEA and DEG-Enrichment.

Information Theoretic Similarity (ITS) (FIGS. 4, 5, 6).

We calculated the similarity between GO-BP terms using Jiang's information theoretic similarity that ranges from 0 (no similarity) to 1 (perfect match).

Precision-Recall Curves (FIGS. 4-5).

Using the R statistical software, we computed two types of Precision-Recall curves: (i) internal validations (FIG. 4) and (ii) external validations (FIG. 5) of the GO-BP mechanism predicted by the N-of-1-pathways method (Cross-Patient; see above). INTERNAL VALIDATION: Precision-recall curves of the “internal validation” compare the N-of-1-pathways Predictions of GO-BP from the exploration dataset with the GO-BPs predicted on the same dataset by GSEA and DEG-Enrichment that alternatively serve as “Proxy Gold Standard”. EXTERNAL VALIDATION: The GO-BPs predicted in the exploration dataset from all three methods (N-of-1-pathways, GSEA and DEG-Enrichment) are compared to those obtained in each of the external datasets (considered as Gold Standards). STANDARD PRECISION-RECALL CURVE: The Gold Standards GO-BPs are fixed, while each precision and recall point of each GO-BP prediction method is ranked either according to its p-values (GSEA and DEG-enrichment) or the number of patients (N-of-1-pathways). The precision and recall values are calculated using different cutoffs of the ranked GO-BPs from the prediction methods. In this case, a true positive is calculated as an overlap between a prediction and the gold standard. A true negative corresponds to a GO-BP neither predicted nor found in the Gold Standard. A false positive is a predicted GO-BP not found in the Gold Standard, and a false negative is a Gold Standard not predicted GO-BP. INFORMATION-THEORY SIMILARITY (ITS) IN PRECISION-RECALL CURVE: in this type of precision-recall curve, we consider a true positive prediction if the predicted GO-BP is similar to a GO-BP from the Gold Standard or from the Proxy Gold Standard (ITS≧0.7). We have previously shown that an ITS score ≧0.7 robustly corresponds to highly similar GO terms using different computational biological validations: protein interaction, human genetics, and Genome-Wide Association Studies.

Concordance of GO-BP Predicted in External Studies (FIG. 5A).

The concordance of predicted GO-BPs at FDR≦5% between the three external studies is compared using the overlap drawn as a Venn diagram. GO-BPs of external validation study I were taken directly from the manuscript as the authors did not provide either deregulated genes, or expression data (link broken). For studies II and III, significant GO-BPs were calculated by GSEA and DEG Enrichment adjusted at FDR≧5%.

Heatmap (FIG. 6A).

The heatmap drawn in FIG. 6A is computed using the default clustering parameters of the HeatPlus package in R (distance metric=Euclidean and aggregation method=complete). It is created from the exploration dataset by taking the Z-Scores (computed from the N-of-1-pathways p-values using qnorm in R) from the 905 deregulated GO-BP terms found in at least one over the 55 patients. We also provided three sub-panels that are illustrated in the bottom of the heatmap. The first one (named Patient Count) contains the number of patients sharing the corresponding deregulated pathways (over 55). The second sub-panel (called GO-BP Classes), manually categorized into 10 meta-groups, shows how the GO-BP pathways are spread. The last sub-panel (called GO-ITS Analysis) shows the overlap and similarity between N-of-1-pathways applied on the exploration dataset, and a comprehensive Gold Standard (GS) built from the union of the GO-BPs that were statistically derived using DEG Enrichment in each of the three external studies. These pathways unveiled by the N-of-1-pathways method can be either (i) in perfect overlap with GS (ITS=1), (ii) highly related to GS (1>ITS≧0.7; not shown because uninformative), (iii) related to GS (0.7>ITS≧0.3), or (iv) unrelated to the GS (ITS<0.3). The predicted GO-BPs from N-of-1-pathways in the exploration dataset were manually curated by a molecular biologist into classes (heatmap, first subpanel).

Cox-Regression Survival Curves (FIG. 6B).

The survival curves have been computed using GraphPad Prism v6.02 software. They were calculated using the survival data associated to the exploration dataset (n=55). 16 patients are curated as “tumor-free” or “unknown tumor recurrence status” but dying in the first 12 months and thus were excluded. The patient clusters were obtained given two different techniques: (i) the heatmap clustering (computed in R with hclust function; aggregation method parameter=complete) (ii) the Partitioning Around Medoids (PAM) clustering method (computed in R with cluster package). Clinical data (including survival) were downloaded from TCGA website on Mar. 15, 2013.

### Results of Example 1

FIG. 3. Synthetic Data: Evaluation of Size and Ratio of Concordant Deregulated Genes within a Pathway Required to be Found Deregulated in the N-of-1-Pathways Method.

Each point represents one size of a simulated pathway generated by randomly selecting n genes and a ratio r of the deregulated genes within the pathway. The ratio r is artificially increased by a 2-fold change in the simulated pathway. For each value (n, r), we then applied the N-of-1-pathways model using Wilcoxon test, and performed an empirical p-value resampling 1,000 times. The unadjusted p-values reported in FIG. 3 are computed as the number of time the simulated pathway is not found to be deregulated divided by 1,000.

The N-of-1-pathways method successfully identifies deregulated pathways in a synthetic simulation. The method that we developed, “N-of-1-pathways”, is the validation of a non-parametric statistical based-method, applied to single patient paired samples, rather than a larger multi-sample based patient cohort. It assumes that the RNA of a single patient is the population and the patient is the mathematical universe. Cross-patient studies tend to generalize commonly found pathways whereas our unconventional approach straightforwardly delineates unique pathways. FIG. 3 confirms the obvious: genesets containing less genes (n) require a larger proportion of deregulated genes (r) to be recognized as statistically significant by N-of-1-pathways. Since we applied our method on simulated pathways from a single randomly selected paired sample in the above analysis, we only considered unadjusted p-values.

Internal Validation: N-of-1-Pathways Unveiled Deregulated Pathways Comparable to Those of Conventional Geneset-Level Methods.

In order to assess the accuracy of our methodology, N-of-1-pathways, we compared the union of the deregulated genesets derived from N-of-1-pathways, applied to each of 55 patients (905 for Bonf. 1% cutoff and 2662 for FDR 5% cutoff), to the genesets of the following conventional enrichment methods: GSEA and DEG enrichment. Because the N-of-1-pathways method identifies deregulated genesets for each patient, we grouped these results together by counting the number of patients in each found deregulated geneset. Throughout the study, genes annotated to GO biological processes (GO-BP) serve as genesets. We found 1,659 differentially expressed genes in the exploration set (480 down- and 1,179 up-regulated) that we further enriched into 65 GO-BP associated-pathways using a Fisher's Exact Test (FET) (DEG Enrichment, Methods). Second, we identified a second group of 725 GO-BP at FDR≦5% using GSEA (Methods). In order to evaluate the effectiveness of the N-of-1-pathways method, we compared the pathways uncovered at the single patient-level to those found by DEG Enrichment using GSEA as a proxy-gold standard (FIG. 4).

We also used an Information Theory Semantic Similarity technique (Methods) to relate the highly predicted GO-BP terms to those of the gold standard, using a cutoff we have previously derived as significant (ITS≧0.7; Methods). Results show that the N-of-1-pathways outperforms the DEG Enrichment method using GSEA as a Proxy Gold Standard (FIG. 4A-4B). We also calculated the corollary accuracy plots where DEG Enrichment serves as a Proxy Gold Standard in which the N-of-1-pathways method shows a slightly better precision and recall than GSEA (data not shown, maximum precision ^{˜}35%). The lower precision observed for both GSEA and N-of-1-pathways when DEG Enrichment is used as a Proxy Gold Standard is likely related to the lower number of GO-BP terms of the latter (over-conservative gold standard).

External Validation: Biological Relevance of the Deregulated Pathways Found in the Context of Lung Adenocarcinoma.

In order to further assess the accuracy of the pathways we found deregulated in the exploration dataset, we used three independent lung adenocarcinoma studies described in Table 1 to derive Gold Standards (Methods). In FIG. 5, the GO-BP genesets found deregulated across patients in the exploration set were compared to those found deregulated in each of the three independent validation studies. We used ITS>0.7 semantic similarity threshold for these curves. We conducted GSEA and DEG Enrichment methods on the exploration dataset using the GO-BP terms published in study I (FIG. 5B) and GO-BP Terms enriched with both DEG Enrichment and GSEA in studies II and III (FIG. 5C-5F respectively). The N-of-1-pathways (Bonf.≦1% and FDR≦5%) predictions from the exploration set are comparable, or better, to those of GSEA and DEG Enrichment while selecting GSEA as a Gold Standard. When DEG enrichment is chosen as a GS, N-of-1-pathways underperformed DEG enrichment but generated comparable precision and recall as GSEA. Further exploration shows that GSEA outperforms DEG Enrichment when the Gold Standard is derived from GSEA and vice-versa when the GS is derived from DEG Enrichment. Thus, it appears that pooled N-of-1-pathways predictions across patients are more related to those of GSEA.

In FIG. 5A, there is a modest GO-BP pathway overlap between all three validation studies. When comparing the overlap of two studies, the commonality is modest to moderate. This observation concurs with the reports that lung adenocarcinoma cancer is a very complex and heterogeneous disease. Further, these results also suggest that there is a high heterogeneity and convergence of molecular mechanisms underlying both disease development and chemoresistance. These results support our initial hypothesis that patient-specific interpretations of deregulated pathways are required. However, the stronger overlap found between studies II and III suggests a confounded artifact: an increased overlap due to the enrichment method used. We confirmed this issue by comparing GSEA with DEG Enrichment on the same datasets and across datasets (data not shown).

Single Sample Analysis Unveils Individual and Shared Patient Associated-Pathways.

As a last step, we assessed the biological relevance of the pathways uncovered by the N-of-1-pathways method to underline unique and shared deregulated pathways among patients, and relate these pathways to survival outcomes. Using Z-Scores of each of the 905 GO-BP found deregulated in at least one of the 55 patients, we conducted a hierarchical clustering of patients and mechanisms (Heatmap FIG. 6A; Methods). In addition, three additional analyses are presented in FIG. 6A: (i) the number of patients sharing any given pathway (patient count), (ii) the distribution of the GO-BPs grouped in curated classes (GO-BP Classes; Methods), and (iii) the similarity of predicted GO-BPs to the Gold Standard based on information-theoretic similarity (Methods).

FIG. 6A shows a heatmap generated by the matrix of Z-Scores for each patient (in rows) and each GO-BP Term found significantly deregulated in at least one patient over 55 (in columns) in the exploration dataset. Below the heatmap, three panels show different information associated with each GO-BP Term: the number of patient sharing the given pathway, the curated categorization of the GO-BP Terms, and the association with the Gold Standard created from the union of the three external studies. FIG. 6B shows two survival studies conducted in the exploration set; the first one is created from the three clusters shown on the heatmap (overall p=0.24, best curve p=0.14) and the second one is created from three clusters computed by PAM clustering on the same data (overall p=0.09, best curve p=0.03). 16 patients were excluded from the survival study due to lack of follow-up while the remaining 39 patients may not provide sufficient statistical power to obtain significance; nonetheless, we provided the p-values to illustrate the trends.

Further, clusters of GO-BPs are highlighted by a background color that underlines patterns that correlate patient counts to GO-BP classes. The most striking cluster (grey, rightmost) contains nearly half of the deregulated GO-BPs genesets, each shared by less than ten patients (20%). This cluster comprises the majority of the GO-BP terms for metabolic process/transport signaling/molecular pathway, tissue/organ development, and immune response. These GO-BP classes can be attributed to the results of inherent property of individuals or response to therapy. In contrast, the leftmost clusters of GO-BPs comprise 25 to 49 patients each (FIG. 6A, patient count, pink, yellow, and green) and pertain almost exclusively to DNA repair chromatin assembly, cell division/cell cycle, and RNA processes. This cluster relates to GO-BP classes that are commonly found in cancer gene-level and pathway-level gene expression profiles. Further, these GO-BP classes are almost absent from the grey cluster. However, the grey and blue clusters share nearly all the immune response GO-BPs and may infer a patient's response to therapy or tumor progression.

GO-ITS study provides comprehensive information on GO terms that are overlapped by the N-of-1-pathways method and the union of the three external validation studies used as Gold Standard. Here are few examples of related GO terms at different ITS thresholds: with perfect overlap (ITS=1), GO:0000087, M phase of mitotic cell cycle shared by 49 patients; highly related (ITS=0.85) GO:0045619, regulation of lymphocyte differentiation shared by 2 patients; somewhat related (ITS=0.7) GO:0031667, response to nutrient levels; unrelated (ITS=0.25) GO:0032259, methylation.

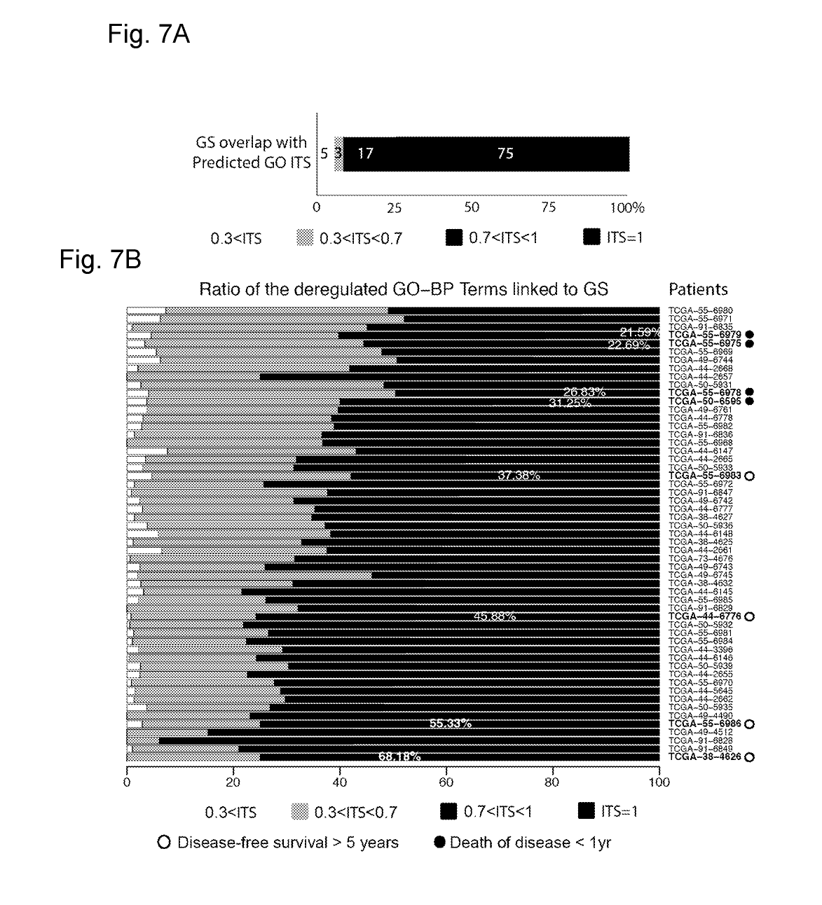

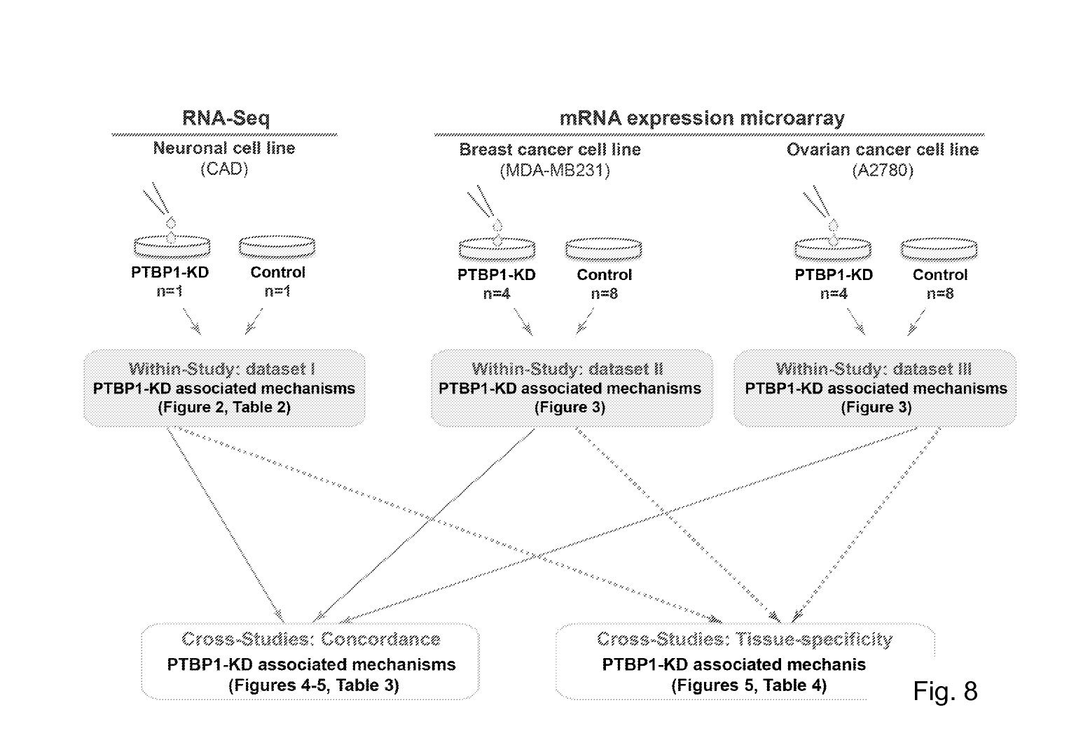

FIGS. 7A and 7B Illustrate a Count of GO-BPs Predicted by N-of-1-Pathways in the Exploration Dataset and their Similarity to Those of the Gold Standard Derived from the Three Validation Studies (and Vice-Versa).

Of note, only one GO-BPs of the Gold Standard from the union of the three validation studies could not be related by ITS>0.3 to the GO-BPs derived from N-of-1-pathways in the exploration dataset (ITS=0.22, GO:0007585, respiratory gaseous exchange). Conversely, approximately 30% of predicted GO-BPs overlap with the GS, while 60% are related (ITS>0.3) and 10% GO-BPs remain unrelated.

Comparison to previous work, limitations, and future studies. Single patient DNA-Seq analyses of cancer versus normal tissues identifies somatic mutations, which can thereafter be straightforwardly enriched into pathways. In this present study, we shown that N-of-1-pathways is highly accurate and offers a step forward solution from elementary approaches.

We and others have previously developed a single sample scoring method that outperformed gene expression classification; however, these scoring systems are designed for interpretation of a single patient against a reference standard or against a geneset-level classifier previously calculated from a cohort. In contrast, N-of-1-pathways method is applicable to experimental designs with as few as two samples (e.g. cell lines exposed to a treatment with a matched control without treatment). In future studies, we plan to evaluate N-of-1-pathways in vitro.

Furthermore, from FIG. 5, it appears that N-of-1-pathways with N=55 can outperform GSEA and DEG enrichment; we plan to conduct a number of studies to quantify the gain of accuracy obtained with N-of-1-pathways. We will start with resampling decreasing subsets of patients to estimate when the N-of-1-pathways becomes no more accurate than alternate methods conducted over the full dataset of 55 patients. Further, we have started to compute empirical studies (10,000 permutations, data not shown) to calculate the p-value associated to a GO-BP pathway identified across patients, using N-of-1-pathways. This approach yields better ranking of GO terms than the simple count of number of patients used in this current study. In addition, we consider using uncurated biomodules to generate genesets required for N-of-1-pathways from co-expression patterns or yeast-2-hybrid protein interactions. We have previously shown improvement of geneset scoring methods with biomodules rather than curated genesets. Finally, with the abundance of microarray datasets, an analysis of the accuracy might be valuable for obtaining a signal in microarrays by re-analyzing well-understood legacy datasets with the intent to unveil individual differences overlooked by cross-patient studies.

Finally, TCGA contains paired DNA-sequencing of normal and lung adenocarcinoma for the same patients of the RNA-Seq exploration dataset, from which somatic mutations can readily be extracted. We plan to improve analytical techniques for N-of-1 genomic studies through the use of additional sources of external knowledge (e.g. eQTL) and paired samples from other genomic scales. Indeed, the new pathologic classification of lung cancer identifies key mutations relevant to chemoresistance and disease progression such as EGFR, ALK, TTF-1, p53 and KRAS.

### Conclusion for Example 1

In this study, we validated a novel approach, N-of-1-pathways, for unveiling deregulated pathways from only two paired samples. In classic comparative study analyses, many samples of different categories are required for achieving sufficient statistical power to draw conclusions at the level of the studied population. Here the power is available for a single patient with as few as 2 samples, yet population-based generalizations can be conducted in a deceptively simple way: by adding significant patient results together. We compared the results of N-of-1-pathways with two well-known methods: GSEA and DEG enrichment, which are current state of the art techniques for identifying deregulated pathways from multiple samples. The results show that our method not only obtained comparable or better results, but also could be effectively used to identify the deregulated pathways at the patient level.

About 20% of pathways deregulated in individual patients were overlooked in three previous well-powered studies; yet, some were shared by a number of patients. This highlights the variability of individual patients that can be further stratified as subgroups at the molecular level, a squandered opportunity of legacy studies. In comparison, the N-of-1-pathways approach provides a significant “differentia” likely to find valuable use in precision and molecular medicine, a nascent field lacking in robust quantitative and qualitative methodologies.

Taken together, the increased accuracy for population-based study and the sub-group stratification empowered by this method prepares the path to leverage individual molecular data for profoundly improved mechanistic classifiers of prognosis and chemotherapeutic response. For example, patients having tumors with greater numbers of dysregulated genes may benefit from aggressive surgery and chemotherapy using multiple simultaneous antineoplastic agents, while those with less dysregulation may benefit from less aggressive treatment that may produce fewer side effects.

### Example 2

We conducted these studies to unveil deregulated mechanisms in the context of the alternative splicing factor protein PTBP1 knockdown (Polypyrimidine tract-binding protein 1). PTBP1 was previously reported as a key player in alternative splicing of many genes associated to lineage-specific cell differentiation or tumor genesis, such as cell cycle. We previously demonstrated that PTBP1 depletion inhibits tumor growth, colony formation and invasiveness in vitro in ovarian tumor cells. Transcriptome analyses of PTBP1-depleted cells uncover deregulated genesets (mechanisms) and thus, offer potential therapeutic target discovery. We used one previously reported single paired RNA-Seq sample as well as our new datasets derived from breast and ovarian cancer cell lines, and PTBP1-depleted and matched control samples. We hypothesized that deregulated mechanisms identified in individual samples enable pooled analyses for both “shared pathways” as well as individual results. Further, we compared the “pooled” results with those obtained by conventional geneset enrichment analyses (i) within each dataset (consistency) and (ii) across datasets (validation).

### Methods

TABLE 2
Transcriptome Datasets for Example 2

| Description | | Dataset I | Dataset II | Dataset III |
|---|---|---|---|---|
| Cell line | | Neuronal cell line | Breast cancer cell | Ovarian cancer cell |
| | | (CAD) | line | line (A2780) |
| | | | (MDA-MB231) | |
| Samples: PTPB1-KD | | 1 (1) | 4 (8) | 4 (8) |
| (controls) | | | | |
| References | Authors | Yap K at al. | Gardeux V et al. | Gardeux V et al. |
| | Source | Genes & Dev. | TBC 2013 | TBC 2013 |
| | Date | Downloaded 01- | 2013 | 2013 |
| | GEO ID | GSE37933 | Submitted to GEO | Submitted to GEO |
| Expression | Type | RNASeq | Micorarray | Micorarray |
| measurements | | | GeneChip | GeneChip |
| | Platform | Genome analyzer | PrimeView Human | PrimeView Human |
| | | IIx Illumina | Gene Expression | Gene Expression |
| | | | Array | Array |

| | | | |
|---|---|---|---|
| Measured transcripts or probes | 27389 | 49395 | 49395 |
| Deregulated transcripts or | 707 | 720 | 469 |

Dataset Description.

Three transcriptome datasets pertaining to PTBP1-depleted cell lines and matched controls were used: Datasets I, II and III. Descriptions are summarized in Table 2 and details of their respective experimental design 5array Average (RMA) technique, using Affymetrix Power Tools (APT).

Gene Ontology Annotations of Biological Processes (GO-BP).

We aggregated genes into pathway-level mechanisms using Gene Ontology Biological Process, GO-BP. Hierarchical GO terms were retrieved using the org.Hs.eg.db package (Homo Sapiens) and the org.Mm.eg.db package (Mus Musculus) of Bioconductor, available for R statistical software. We used the org.Hs.egGO2ALLEGS database (downloaded on Mar. 15, 2013), which contains a list of genes annotated to each GO term (geneset) along with all of its child nodes according to the hierarchical ontology structure. The genesets were filtered so that only those sized between 15 and 500 were kept in the studies. These GO annotations were used for three types of GO prioritization analyses: GSEA, DEG Enrichment and N-of-1-pathways analysis (described below in Methods).

Kyoto Encyclopedia of Genes and Genomes (KEGG).

We aggregated genes into pathway-level mechanisms using Kyoto Encyclopedia of Genes and Genomes, KEGG. KEGG pathways were retrieved using the org.Hs.eg.db package (Homo Sapiens) and the org.Mm.eg.db package (Mus Musculus) of Bioconductor, available for R statistical software. We used the org.Hs.egPATH database (downloaded on Mar. 15, 2013), which contains a list of genes annotated to each KEGG pathway (geneset). The genesets were filtered so that only those sized between 15 and 500 were kept in the studies. These KEGG annotations were used for three types of KEGG prioritization analyses: GSEA, DEG Enrichment and N-of-1-pathways analysis.

N-of-1-Pathways Method Applied to In Vitro/In Vivo Experiments.

MECHANISMS PRIORITIZED WITHIN ONE PAIR OF SAMPLES: The N-of-1-pathways method was performed on the three datasets (Table 2, Datasets I, II, III) independently for each paired sample (PTBP1-KD and control, FIG. 8). The first set of the proposed method consists of a non-parametric paired Wilcoxon test (Wilcoxon signed-rank test) performed within each sample on the paired gene expression profiles restricted to a given mechanism. Wilcoxon statistics, W⁺ and W⁻, provide direction on deregulated genesets as overall “up-regulated” or “down-regulated” respectively. Both FDR and Bonferroni (Bonf.) corrections were applied to adjust p-values for multiple comparisons. In each paired sample, only deregulated pathways or mechanisms with adjusted p-values with FDR≦5%, Bonf.≦1% or Bonf.≦5% were retained for further analysis. MECHANISMS PRIORITIZED ACROSS MULTIPLE PAIRS OF SAMPLES: For comparison of the N-of-1-pathways method with cross-patient enrichment of mechanisms, a second step is required to prioritize the mechanisms otherwise found in individual pairs of samples. Each mechanism has an associated p-value for each paired sample. The p-values were then ranked according to the total number of samples sharing a given mechanism that reached significance at Bonf.≦1% (default suggested cutoff parameter). The prioritized mechanisms were listed from the most commonly to the least observed across samples, yet significant in at least one sample. Adjusted p-values are then transformed into Z-scores for further within- and cross-samples analyses. The N-of-1-pathways software is available in R and Java at http://Lussierlab.org/publication/N-of-1-pathways.

Gene Sets Enrichment Analysis (GSEA).

Gene set enrichment analysis was conducted on breast and ovarian cancer datasets only (Table 2, Datasets II, III). In the case of the neuronal dataset, GSEA was not performed as it is underpowered with a single pair of samples (Table 2 and FIG. 8, Dataset I). The GSEA v2.0.10 software was used with the default parameters except for the permutation parameter selection, which was set to “geneset” instead of “phenotype”. Geneset permutation was chosen to achieve enough statistical power for permutation resampling due to the small number of samples.

Mechanisms Enriched from Differentially Expressed Genes (DEG Enrichment).

Enrichments of GO-BP and KEGG genesets with differentially expressed genes (DEG) were conducted in the R statistical software using the Fisher's Exact Test (FET) based on the following contingency table: (DE genes, All Genes)×(In Pathway, Not In Pathway). Adjustment for multiple comparisons was performed using Benjamini and Hochberg method (False Discovery Rate; FDR), and pathways with FDR≦5% were considered significantly enriched. Of note, the up-regulated and down-regulated genes were enriched independently. DEGs were directly available for neuronal RNA-Seq study (Table 3, Dataset I) while DEGs of the breast and ovarian cancer studies (Table 3, Datasets II, III) were calculated in the following way: (i) genes whose average expression differs by at least 2-fold between Control (8 samples) and PTBP1-KD samples (4 samples) were selected for analysis, (ii) then a t-test was applied between the two groups, and p-values were adjusted with Benjamini and Hochberg method (False Discovery Rate; FDR). Only DE genes with FDR≦5% were retained.

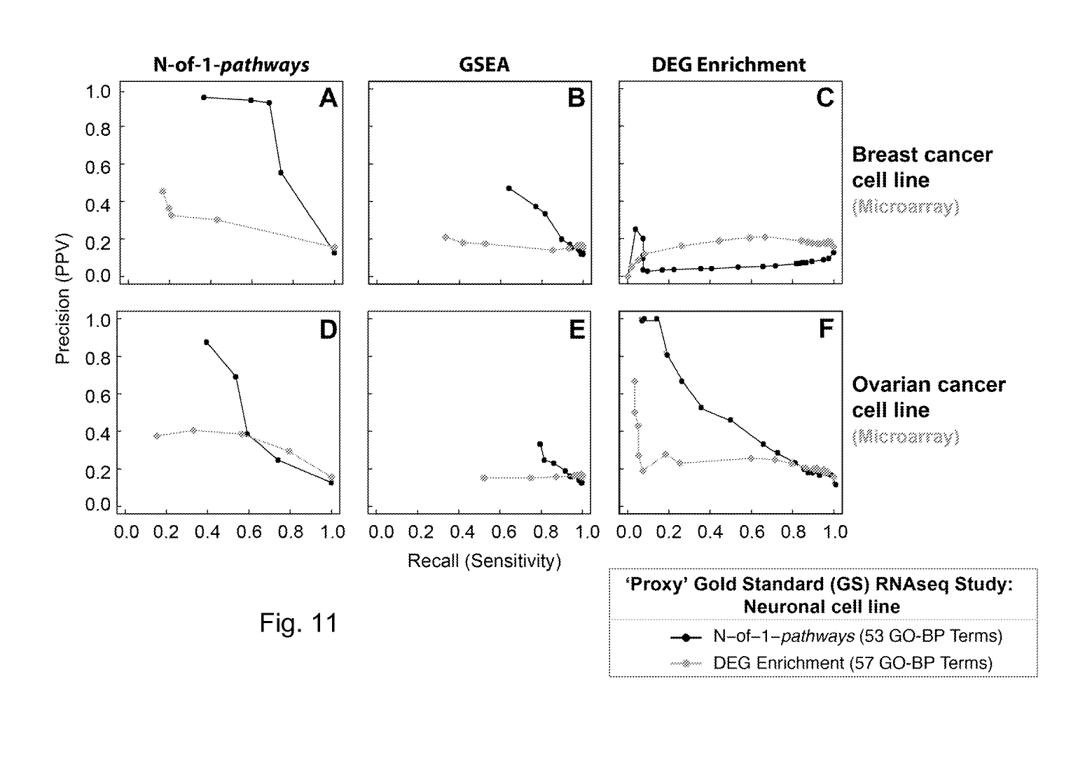

Information Theoretic Similarity (ITS) (Only Applicable for GO-BP Mechanisms; FIGS. 10 and 11).

In order to further stratify mechanisms in those that are unique to a pair of samples or common to multiple samples, Information-Theory Similarity (ITS) is utilized to formally assess similarity cross sample pairs versus uniqueness to a pair. When applied on samples from an individual patient, this method allows determining pathways unique to a patient versus those common to many, a step forward in personal therapy from transcriptome data. We calculated the similarity between GO-BP terms using Jiang's information theoretic similarity that ranges from 0 (no similarity) to 1 (exact match).

Within-Study Proxy Gold Standard (FIG. 10).

Mechanisms are statistically prioritized in breast and ovarian cancer datasets by the three above described methods: N-of-1-pathways, GSEA and DEG-Enrichment. The accuracy of the N-of-1-pathways method was compared to one of the conventional methods (e.g. DEG Enrichment) while the other serves as a Proxy Gold Standard (GSEA).

Cross-Studies Derived Gold Standards (FIG. 11).

Significant deregulated mechanisms in PTBP1 depleted neuronal cell lines unveiled by N-of-1-pathways and DEG Enrichment methods (Table 2, Dataset I) were used as Proxy Gold Standard. For the DEG Enrichment method, the list of DEG was directly provided by the authors and further enriched. These two lists of mechanisms serve as derived Gold Standards to compare their robustness across studies, methods, and underpinning biology (PTBP1 depleted cells; mouse versus human, neuronal versus cancer cell lines; breast versus ovarian cancer cell lines.)

Precision-Recall Curves (FIGS. 10, 11).

Using the R statistical software, we computed two types of Precision-Recall curves: (i) within-study (FIG. 10) and (ii) cross-studies (FIG. 11) of the mechanisms predicted by the N-of-1-pathways (Cross-samples; see above), GSEA and DEG Enrichment. WITHIN-STUDY: Precision-recall curves of the “internal validation” compare breast and ovarian cancer GO-BP and KEGG associated mechanisms unveiled by the N-of-1-pathways with those predicted by DEG Enrichment and GSEA that were used alternatively as “Proxy Gold Standard” (Proxy GS) (FIG. 10). CROSS-STUDIES: Breast and ovarian cancer GO-BP and KEGG associated mechanisms uncovered by the N-of-1-pathways, GSEA and DEG Enrichment were compared to those found in the RNA-Seq neuronal dataset by the N-of-1-pathways and DEG-Enrichment (considered as GS) (FIG. 11). STANDARD PRECISION-RECALL CURVE: The GS list of deregulated mechanisms are fixed (given a particular cutoff) while the precision and recall point of each mechanism identification method is ranked either according to its p-values (GSEA and DEG Enrichment) or the number of samples (N-of-1-pathways). The precision and recall values are calculated using different cutoffs of the ranked mechanisms derived from the prediction methods. In this case, a true positive is calculated as an overlap between a prediction and the GS. A true negative corresponds to a mechanism neither predicted nor found in the GS. A false positive is a predicted mechanism not found in the GS while a false negative corresponds to non-predicted GS mechanism. INFORMATION-THEORY SIMILARITY (ITS) IN PRECISION-RECALL CURVE (only applicable for GO-BP mechanisms): for these precision-recall curves, we considered a true positive prediction if the predicted mechanism is similar to a mechanism from the GS (ITS≧0.7). We have previously shown that an ITS score ≧0.7 robustly corresponds to highly similar GO terms using different computational biological validations: protein interaction, human genetics, and Genome-Wide Association Studies.

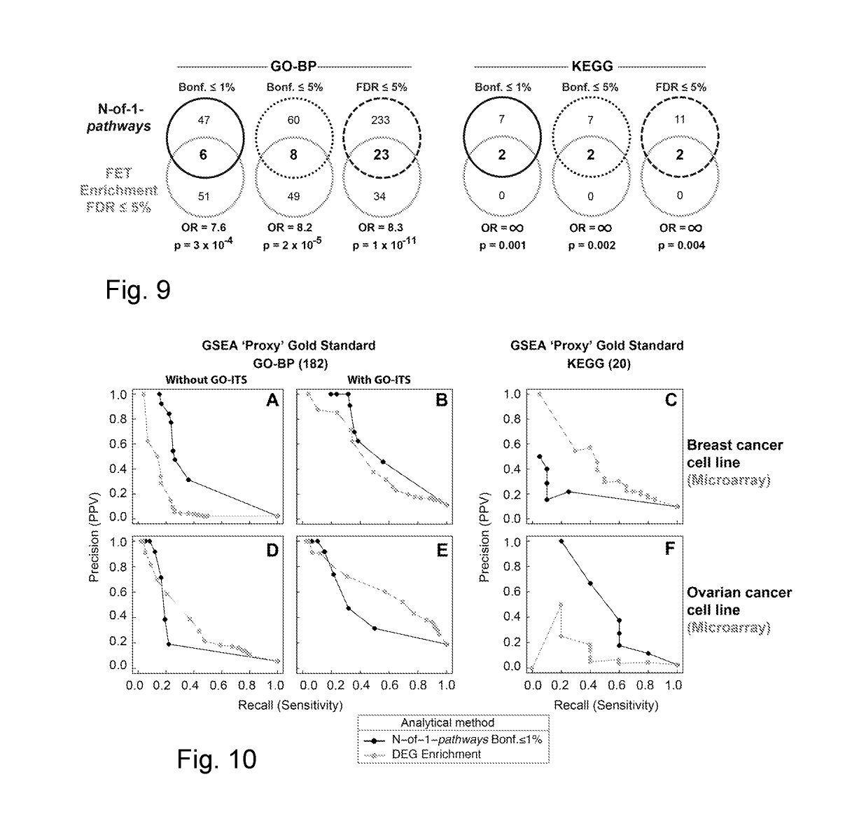

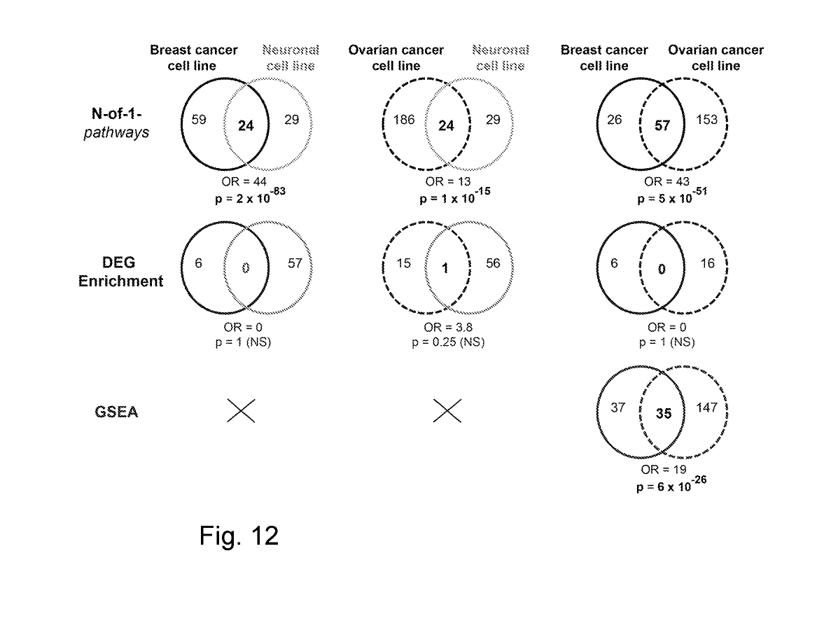

Statistical Significance of Overlap of Two Lists of Mechanisms (Odds Ratio, OR; and p-Value; FIGS. 9, 12).

In order to assess the statistical significance of mechanism overlap unveiled by two different methods, we computed the following contingency table: (#Overlapping mechanisms, #Non-overlapping mechanisms in method 1)×(#Non-overlapping mechanisms in method 2, #Remaining mechanisms in mathematical universe). We then computed an odds ratio (OR) and a p-value using the Fisher's Exact Test (FET). The computed p-value obtained with FET is equivalent using a Hypergeometric Test.

### Results

Overview of the Datasets and Performed Studies.

FIG. 8 provides an overview of the experimental design. We evaluated the robustness of the N-of-1-pathways method in three transcriptome profile datasets: a single paired sample (RNA-Seq from mouse neuronal cell line, Dataset I) and two small set of paired samples (mRNA expression microarray from human breast and ovarian cancer cell lines, Dataset I and II). All paired samples consist of a number (n) of PTBP1-depleted cells (PTBP1-KD) and matched control cells. To uncover PTBP1-KD associated mechanisms, we first performed within-study analyses (N-of-1-pathways, GSEA, DEG-pathways) independently for each of the datasets I, II and III (Methods, FIG. 10, 11; Table 3; GSEA was not applicable to Dataset I). We then quantitatively and qualitatively compared the three analytical methods across the three studies to reveal concordant and tissue/cell specific deregulated mechanisms associated to PTBP1-KD (FIGS. 11-12; Tables 3-4). Within-Study concordance of PTBP1-KD associated mechanisms unveiled by N-of-1-pathways and DEG Enrichment in neuronal cell line (Dataset I). We first performed an independent within-study analysis from published RNA-Seq transcriptome profile of PTBP1-depleted neuronal cell lines (Dataset I; Table 3; FIG. 9). To apply geneset-level enrichment analysis, conventional methods such as, GSEA require three samples to reach statistical significance. The present dataset I consists of a single sample of PTBP1-KD and a single paired Control (n=2). We applied our proposed method, N-of-1-pathways, that is designed for these experiments and conducted a DEG Enrichment analysis (GSEA cannot be applied). Arguably, DEG Enrichment is barely applicable with n=2, since only a fold change of differentially expressed genes between two samples can be measured and considered for further analysis. There is no known method that can compute a p-value at the mRNA level (gene-level) from a single paired sample analysis of RNA-seq transcriptome. We then show significant overlap of PTBP1-KD associated mechanisms prioritized by both methods using GO-BP and KEGG genesets (FIG. 9; p<0.05; Odds Ratio: OR>7). The different Odds Ratios (OR) were comparable regardless of the multiple comparison cutoffs of the N-of-1-pathways method (Bonf.≦1%, Bonf.≦5%, FDR≦5%). In order to limit the number of false positive results for N-of-1-pathways and produce succinct (human interpretable) lists of mechanisms, we favored a Bonferroni ≦1% in the remainder of this paper while we kept a FDR≦5% for GSEA and DEG Enrichment. Thereafter, we evaluated the biological relevance of such GO-BP associated mechanism overlaps between N-of-1-pathways and DEG Enrichment (FIG. 9 leftmost panel; Table 3). Six GO-BP were found overlapping and ten others were found related based on ITS semantic similarity computed score (ITS≧0.7, Methods). All together, the 16 mechanisms belong to three GO-BP classes: Cell Cycle/DNA Replication, DNA repair and neuronal transmission. Indeed, N-of-1-pathways recapitulates the tissue-specific deregulated mechanisms of synaptic transmission and synaptic vesicle exocytosis that were previously confirmed in biologic assays by the study from which the RNA-Seq dataset I was generated. The authors showed that the depletion of PTBP1 affects alternative splicing and triggers transcriptome changes on a large scale, which increased the propensity of the neuronal CAD cells to undergo neuron-like differentiation.

TABLE 3
GO-BP overlap and similarity between N-of-1-pathways and DEG Enrichment
derived from RNA-Seq transcriptome profile of PTBP1-depleted neuronal cell line.

| Curated GO-BP | | GO-Bp | Go-BP | Neuronal |
|---|---|---|---|---|
| classes | GO-BP Terms | overlap | ITS ≧ 0.7* | specific |
| Cell cycle and | GO:0006260: DNA Replication | ✓ | | |
| DNA | GO:0051325: interphase | ✓ | | |
| Replication | GO:0007067: mitosis | | ✓ | |
| | GO:0051329: interphase of mitotic cell | | ✓ | |
| | cycle | | | |
| | GO:0010564: regulation of cell cycle | | ✓ | |
| | process | | | |
| | GO:0033261: regulation of S phase | | ✓ | |
| | GO:0000279: M phase | | ✓ | |
| | GO:0000087: M phase of mitotic cell | | ✓ | |
| | cycle | | | |
| DNA repair | GO:0006974: respone to DNA Damage | ✓ | | |
| | Stimulus | | | |
| | GO:0006281: DNA Repair | ✓ | | |
| | GO:0006310: DNA recombination | ✓ | | |
| | GO:0006302: double-strand break repair | | ✓ | |
| Neuronal | GO:0007268: synaptic transmission | ✓ | | ✓ |
| transmission | GO:0016079: synaptic vesicle exocytosis | | ✓ | ✓ |

*GO-BP terms with Information Theoretic Similarities (ITS) ≧ 0.7 are considered highly related (Methods)

Within-Study, Datasets II and III: Concordance of PTBP1-KD Associated Mechanisms Unveiled by N-of-1-Pathways, DEG Enrichment and GSEA in Breast and Ovarian Cancer Cell Lines.

A within-study analysis independent for two different human cancer cell lines (breast and ovarian cancer; Table 2, Dataset II, III). Each study uses four biological replicates of PTBP1-KD and eight matched control (not depleted PTBP1) samples. We applied GSEA, DEG Enrichment and N-of-1-pathways methods independently on each dataset I and II and compared their accuracies (FIG. 10).

FIG. 10 illustrates WITHIN-STUDY concordance of PTBP1-KD associated mechanisms found by N-of-1-pathways compared to those found by GSEA and DEG Enrichment, applied to breast and ovarian cancer gene expression microarray profile (Datasets II-III). To evaluate the GO-BP and KEGG associated terms of deregulated mechanisms yielded by the N-of-1-pathways method in both breast and ovarian cancer internal studies, we compared these pathways to those found by DEG Enrichment when GSEA is chosen as the ‘Proxy’ Gold Standard (Proxy GS, Methods). We then generated precision-recall curves based on the exact GO overlap (Without GO-ITS, panels A, D), related GO terms by Information Theory Similarity overlap (With GO-ITS, panels B, E; GO-ITS≧0.7; Methods), and the exact KEGG overlap (panels C, F).

FIG. 11 illustrates a CROSS-STUDIES concordance of PTBP1-KD associated mechanisms found by N-of-1-pathways and conventional methods in breast and ovarian cancer cell lines using neuronal cell line mechanisms as Gold Standard. We compared mechanisms unveiled by N-of-1-pathways and DEG Enrichment in neuronal cell lines to those associated in breast and ovarian cancer cell lines and found by all three methods. We set RNA-Seq neuronal cell related results as a ‘Proxy’ Gold Standard (Proxy GS; Methods) and generated precision-recall curves using GO-BP semantic similarity overlap (GO-ITS≧0.7; Methods).

Cross-Studies: Concordance of PTBP1-KD Associated Mechanisms Unveiled by N-of-1-Pathways, DEG Enrichment and GSEA Across all Three Datasets.

Using either N-of-1-pathways or DEG Enrichment as the two alternate Gold Standards (performed in the neuronal cell lines), N-of-1-pathways surpasses well-known methodologies in five out of six predictions conducted in ovarian and breast cancer cell lines (FIG. 11). Specifically, mechanisms discovered by N-of-1-pathways method applied in the RNA-Seq neuronal cell line dataset are highly concordant to those found in breast cancer and ovarian cancer (FIG. 11, Panels A and D). Taken together, the precision and recall curves of each method in breast and ovarian cell lines (vertical columns) and the overall accuracies of GSEA (FIG. 11, Panels B and E) and DEG Enrichment (FIG. 11, Panels C and F) are lower than those of N-of-1-pathways (FIG. 11, Panels A and D), regardless of the GS used (GS from neuronal study). Of note, N-of-1-pathways always outperforms GSEA and DEG Enrichment with only one exception of the latter. Moreover, the concordance of DEG Enrichment fails in breast cancer cell lines (FIG. 11, Panel C) as well as in ovarian cancer cell lines (FIG. 11, Panel F). Therefore, both consistency and robustness of the mechanisms unveiled by DEG Enrichment across datasets are questionable. In summary, these results highlight the advantage of applying the N-of-1-pathways for a single paired sample analysis compared to conventional methods.

To qualitatively assess the biologic relevance of mechanism overlap, we curated the associated and unrelated GO-BP deregulated mechanisms across the three datasets found by the N-of-1-pathways method. As shown in Table 4, N-of-1-pathways discovered the most common and highly related mechanisms previously reported as associated to molecular and cellular phenotypes that are triggered by PTBP1 depletion such as GO:0000398, mRNA splicing via spliceosome and GO:00010564, regulation of cell cycle process. We also studied the dissimilar mechanisms between datasets. Although some deregulated mechanisms could help to decipher tissue-specificity of PTBP1 role in alternative transcription, further investigations are required to understand their underpinning biology.

TABLE 4
Concordance of regulated mechanisms by PTBP1 across three cell lines (neuronal,
breast cancer and ovarian cell lines) discovered by N-of-1-pathways.

| GO-BP | | | | |
|---|---|---|---|---|
| Classes | GO-BP Overlap | | GO-BP ITS ≧ 0.7 | |
| RNA | GO:0008380 | RNA splicing | GO:0000398 | mRNA splicing, via |
| splicing/ | | | | spliceosome |
| RNA | GO:0006397 | mRNA | GO:0000375 | RNA splicing, via |
| processing | | processing | | transesterification reactions |
| | | | GO:0000377 | RNA splicing, via |
| | | | | transesterification reactions |
| | | | | with bulged adenosine as |
| | | | | nucleophile |
| | | | GO:0016071 | mRNA metabolic process |
| | | | GO:0034470 | ncRNA processing |
| | | | GO:0006364 | rRNA processing |
| Cell | GO:0007067 | mitosis | GO:0000279 | M phase |
| cycle/cell | GO:0051301 | cell division | GO:0000216 | M/G1 transition of mitotic cell |
| division | | | | cycle |
| | GO:0000280 | nuclear division | GO:0000082 | G1/S transition of mitotic cell |
| | | | | cycle |
| | GO:0000087 | M phase of | GO:0000086 | G2/M transition of mitotic cell |
| | | mitotic cell | | cycle |
| | | cycle | | |
| | GO:0051325 | interphase | GO:0000236 | mitotic prometaphase |
| | GO:0051329 | interphase of | GO:0051320 | S phase |
| | | mitotic cell | | |
| | | cycle | | |
| | GO:0006260 | DNA | GO:0000084 | S phase of mitotic cell cycle |
| | | replication | | |
| | GO:0007059 | chromosome | GO:0000819 | sister chromatid segregation |
| | | segregation | | |
| | GO:0071156 | regulation of | GO:0006261 | DNA-dependent DNA |
| | | cell cycle arrest | | replication |
| | GO:0010564 | regulation of | GO:0000070 | mitotic sister chromatid |
| | | cell cycle | | segregation |
| | | process | | |
| | GO:0000075 | cell cycle | GO:0007093 | mitotic cell cycle checkpoint |
| | | checkpoint | | |
| | GO:0000226 | microtubule | GO:0045786 | negative regulation of cell |
| | | cytoskeleton | | cycle |
| | | organization | | |
| | GO:0007017 | microtubule- | GO:0010948 | negative regulation of cell |
| | | based process | | cycle process |
| | GO:0048285 | organelle | GO:0007346 | regulation of mitotic cell cycle |
| | | fission | | |
| | | | GO:0051439 | regulation of ubiquitin-protein |
| | | | | ligase activity involved in |
| | | | | mitotic cell cycle |
| | | | GO:0031023 | microtuble organizing center |
| | | | | organization |
| | | | GO:0051327 | M phase of meitic cell cycle |
| | | | GO:0007051 | spindle organization |
| | | | GO:0007126 | meiosis |
| | | | GO:005132 | meiotic cell cycle |
| chromatin | | | GO:001656 | chromatin modification |
| modifications/ | | | GO:0006325 | chromatin organization |
| remodeling | | | GO:0016569 | covalent chromatin |
| | | | | modification |
| | | | GO:0016570 | histone modification |
| | | | GO:0051052 | regulation of DNA metabolic |
| | | | | process |
| DNA | GO:0006310 | DNA | GO:0006974 | response to DNA damage |
| repair | | recombination | | stimulus |
| | GO:0006281 | DNA repair | GO:0006302 | double-strand break repair |
| Neuronal | | | GO:0031644 | regulation of neurological |
| process | | | | system process |
| | | | GO:0007268 | synaptic trasmission |
| | | | GO:0050804 | regulation of synaptic |
| | | | | transmission |
| | | | GO:0051969 | regulation of transmission of |
| | | | | nerve impulse |
| others | | | GO:0007600 | sensory perception |

Cross-Studies: Tissue-Specific and Concordance of Mechanisms Regulated by PTBP1 Unveiled by N-of-1-Pathways, DEG Enrichment and GSEA Across all Three Studies (FIG. 12).

We further evaluate the reproducibility of each mechanism discovery technique and their robustness across studies using Venn Diagrams and Odds Ratios (OR). Interestingly, unlike N-of-1-pathways, the lack of reproducibility of DEG Enrichment results across studies prevents the recovery of significant overlap. While GSEA provided good overlap (OR=19) between breast and cancer cell line datasets, it failed to provide an overlap between these studies and the neurological dataset, as it cannot be applied to a single paired sample studies (e.g. dataset I). In contrast, N-of-1-pathways can be applied robustly in each case scenario achieving overall the best performance with high OR≧13 at significant p-values (p<1×10⁻¹⁵) far surpassing those of GSEA and of DEG Enrichment in every combination of dataset.

FIG. 12. Illustrates CROSS-STUDIES Accuracy of Mechanism Identification Methods Using their Default Parameters.

Strong overlap performance of N-of-1-pathways method. We compared the three different mechanism identification methods (N-of-1-pathways, DEG Enrichment and GSEA) across the three different studies (neuronal, breast and ovarian cancer cell lines). The computed overlaps of PTBP1-KD associated mechanisms are represented by Venn diagrams. Odds Ratio (OR) and p-values (p) are plotted below the Venn diagrams to represent the statistical significance of the overlap (Methods). The symbol “X” marked in the GSEA results represents not computed analysis, as this method cannot be applied to the single paired sample form the neuronal cell line dataset I.

Limitations.

At the biological level, the large extent of shared mechanisms between RNA-Seq (Dataset I) and mRNA expression microarrays (Datasets I and II) attests the sheer ability of N-of-1-pathways to be applied across platforms. However, unlike the neuronal RNA-Seq dataset, the two newly generated datasets submitted to GEO were conducted using microarrays without exon-specificity measures, preventing the identification of alternative transcripts. Therefore, shared mechanisms such as cell cycle, RNA processing, and splicing need further experimental investigations to reveal the underpinning biology of PTBP1 in regards to alternative splicing. At the computational level, simulation across samples is required to establish the dynamic range of precision and recall of N-of-1-pathways as compared to geneset enrichment studies. The methodology should be extended to single samples rather than paired samples using a different unpaired rank statistic and reference samples from GEO (underway). Moreover, as a large number of pathways may be found deregulated within two paired samples, ITS scores could be automated in order to reduce dimensionality and facilitate interpretation of the results.

### Conclusion for Example 2

In the present study, we established a novel methodology, N-of-1-pathways, empowering mechanism-based analysis using as few as two samples. N-of-1-pathways relies on three principles. First, the statistical universe is a single patient or a set of paired samples. Second, mechanisms unveiled within paired samples can be measured from genesets. Indeed, multiple measures for each mechanism can be obtained and a statistic can be derived. Third, the “naive” exact overlap of mechanism's coded terms is not sufficient to assess commonality or differences between patients or between pairs of samples. A formal similarity metric is required to take into account the hierarchy and/or the shared genes among mechanisms' genesets. To extrapolate general population-level conclusions, popular comparative study analyses require achieving sufficient statistical power based on a large sample size. Here, statistical power is attainable despite a small sample size: a single patient (or cell line, or tissue, etc.) with as few as 2 samples. Yet, population-based generalizations can be conducted by merging significant individual results together. Thus, we compared the results of N-of-1-pathways with two conventional methods: GSEA and DEG Enrichment, which are well-known pathway-level techniques applied to large sample sets. So far the results show that our method surpasses previous mechanism-discovery methods even if it was originally designed to identify the deregulated pathways at the single patient- or paired sample-level.

Importantly, novel translational bioinformatics methods provide advanced understanding of the dynamic range of PTBP1 role in regulating alternative transcript expression of genes associated to proliferation, invasiveness, drug-resistance, etc. Such methods offer the opportunity to serve as proof-of-concept, paving the way to potential therapeutic agents to be investigated, such as small molecules and biologics inhibiting aberrant PTBP1 expression as in the case of ovarian cancer and glioma. Further, the N-of-1-pathways method is likely to be scaled up to a new type of mechanism, such as “chromoplexy”. Recently, this unveiled phenomenon showed the interdependency and biologic modularity of somatic mutations from which oncogenicity emerges rather than the old paradigm of one single point mutation to trigger an oncogenic phenotype.

Taken together, the increased accuracy for population-based study and the sub-group stratification empowered by this computational biology method prepares the path to leverage individual molecular data for profoundly improved mechanistic classifiers of prognosis and chemotherapeutic response. Recent DNA sequencing results support the massive somatic mutation differences in individual patient cancers. Therefore, it is important to further develop patient-specific interpretations and high throughput experiments that support off-label medication repositioning for individualized precision therapy.

### Example 3

### Concordance Between Ex Vivo PBMC and In Vivo Human Infections Confirmed by N-of-1-Pathways Analysis of Single-Subject Transcriptome

Background.

We hypothesize that ex vivo human cells response to virus can serve as proxy for otherwise controversial in vivo human experimentation. Of note, comparing the fold change of a few paired measures is the state of the art in human ex vivo assays, which does not scale up to genomics measurements due to excess false positive results. We hypothesize that the N-of-1-pathways framework, previously validated in cancer as examples above, can be effective in understanding the more subtle individual genomic response to viral infection. N-of-1-pathways framework could provide such insight as it is designed to identify deregulated pathways from ontology-anchored gene sets in two paired samples of genome-scale measurements. Finally, we also developed a novel visualization method, similarity Venn diagram, that provides the similar results between two sets of qualitative measures that can be compared by similarity metrics (e.g. ontology, information theoretic distance, etc.).

Method.

N-of-1-pathways computes a significance score for a list of given genesets, using the ‘omics profiles of a mere two samples as input (e.g. normal/tumoral, pre/post-treatment, infected vs non infected cells). We extracted the peripheral blood mononuclear cells (PBMC) of four human subjects, aliquoted in two paired samples one subjected to ex vivo rhinovirus infection. Their deregulated genes and pathways were compared quantitatively and qualitatively as a group to those of 9 human subjects prior and after intranasal inoculation “in vivo” with rhinovirus. We then clustered individual N-of-1-pathways scores to demonstrate that these profiles recapitulated the phenotypes of asymptomatic and symptomatic patients. Additionally, we developed the Similarity Venn Diagram, an efficient and deceptively simple method for comparing results expressed in an ontology organized as a directed acyclic graph.

Results.

We compared the N-of-1-pathways results using two established cohort-level methodologies: GSEA and enrichment of differentially expressed genes. Methodologically, we have extended contingency tables and odds ratio calculation to calculating the significance of Similarity Venn Diagrams. Results are biologically relevant and similar between in vivo and ex vivo studies, both at the genes and enriched pathways levels. Individual patient ROC curves demonstrate that deregulated pathways identified by N-of-1-pathways in PBMC cells of each single subject infected ex vivo recapitulate the biologically relevant pathways observed in vivo in a whole cohort (p=0.004). Further, a principal component analysis of N-of-1-Pathways Scores discriminates asymptotic patients from symptomatic infected patients in vivo (PBMC expression).

Conclusion.

There are less than five published transcriptomes of human viral infections in vivo. We show the first evidence that a novel transcriptome analysis of ex vivo essays has the potential to predict individualized response to infectious disease without the clinical risks otherwise associated to in vivo challenges.

Introduction

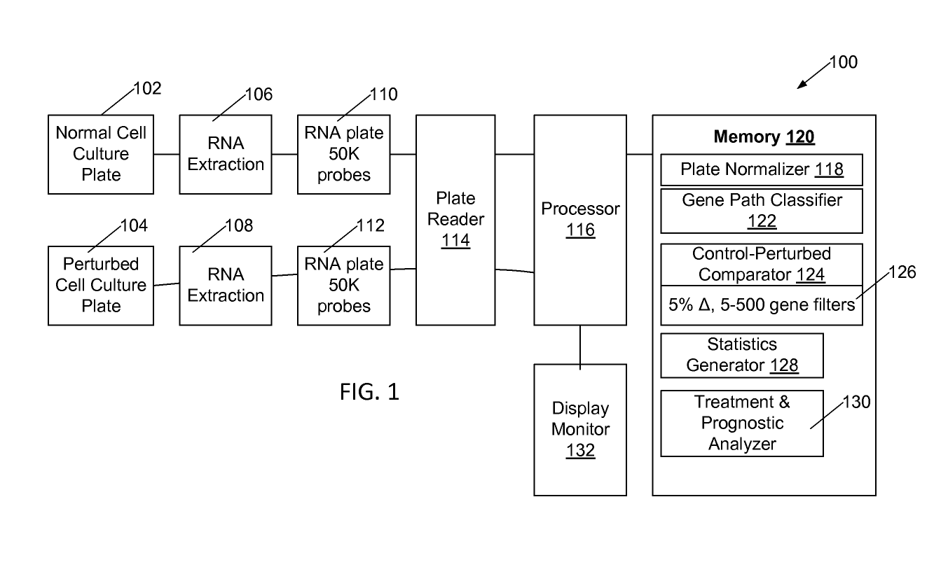

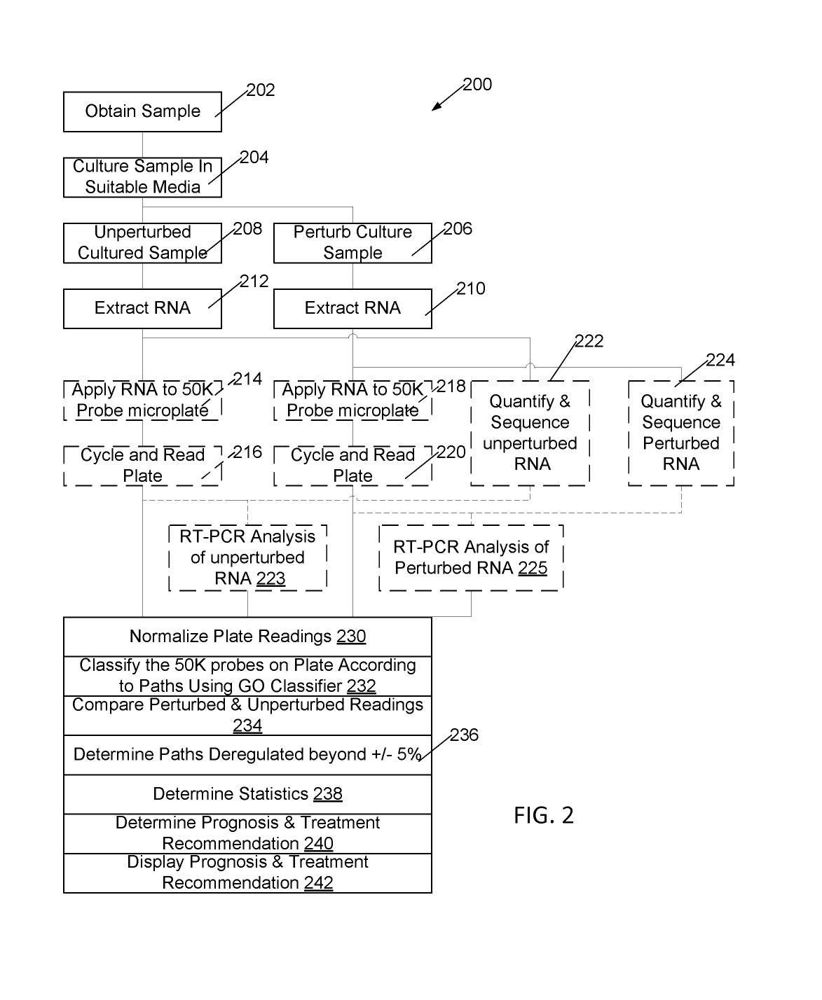

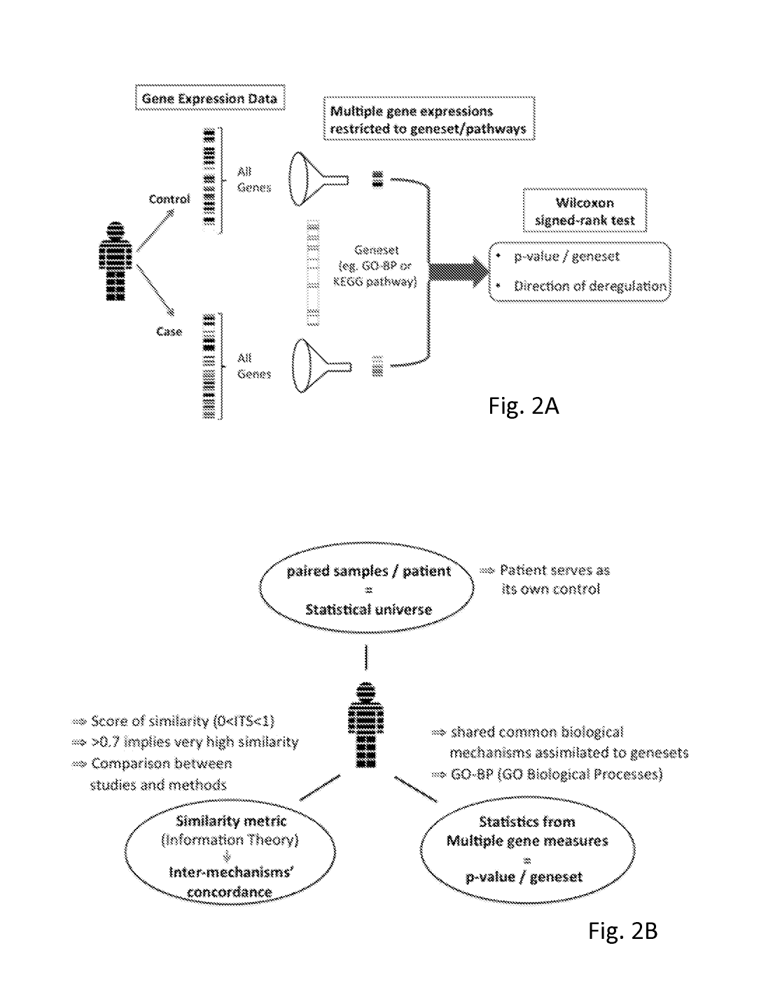

Transcriptomic analysis of the response to a virus can be used for various purposes, involving the understanding of its relation to disease progression, or severity. As discussed above, with reference to FIG. 1 and FIG. 2, we are performing statistical analysis of a normal and a perturbed culture—in this example the perturbed culture is a culture infected with a virus.

In this study, we aimed at analyzing the transcriptomic response of ex vivo virus-exposed Peripheral Blood Mononuclear Cells (PBMC) human cells, and compare it to the in vivo response in the same conditions. We hypothesized that ex vivo analyses can recapitulate in vivo deregulation in this experimental context. To this end, we used well-established enrichment methodologies such as GSEA to assess the pathways at play in presence of a virus. However, those methods of analysis use cohort-based model, which create predictive models based on average/commonly found features across patients, thus overlooking individualized transcriptomic response to stressors that may reveal the summative effect of common as well as private (i) genetic polymorphisms and (ii) epigenetic modifications.

N-of-1-pathways is a framework dedicated to the personalized medicine field that we initially proposed in the context of cancer analyses. It was successfully applied to lung adenocarcinoma visualization of single patient survival, and proved to unveil biologically significant deregulated pathways by using only one pair of samples taken from the same patient in two different conditions (such as before and after treatment, or uninvolved vs tumoral cells). It was also applied in ovarian and breast cancer cell lines to confirm the unsupervised identification of deregulated pathways after a knockdown of PTBP1 and PTBP2 genes that control alternative splicing. In the current study, we aimed at showing that the same N-of-1-pathways framework can be used in very different conditions than cancer, such as the transcriptomic response of virus stress.

In this paper, we propose a novel Similarity Venn Diagram representation for helping readers to understand not only the overlap between two lists of GO Terms, but also their similarity, based on an information-theory equation measuring the semantic similarity between two GO Terms. Further, we demonstrate that this representation can also be used in more general comparison of two lists where a measure of similarity exists for comparing its elements.

Therefore, the major goals of this example are i) to characterize the mechanistic response to rhinovirus, ii) to validate our patient-centered framework, N-of-1-pathways in alternative conditions, and iii) to extend the representation of classic Venn diagrams from simple overlap to more complex similarity comparisons.

### Methods

### Example 3

### PBMCs Incubated with Viruses that Generated the “Human Ex Vivo Infected” Dataset

The live PBMCs had been isolated from blood samples collected from four human subjects under a protocol approved by The University of Arizona Internal Review Board. Whole blood was obtained from donors and placed in heparin tubes that were centrifuged according to standard protocols to obtain PBMCs, then each aliquoted in two paired samples. Each sample of the pair was subsequently exposed to and incubated with either (i) Human Rhinovirus serotype 16 obtained from the American Type Culture Collection (RV; ATCC® VR-283; ex vivo infected sample), or to (ii) sterile medium (control ex vivo non-infected sample) and incubated at 35° C. for 24 hours. This protocol resulted in 4 ex vivo infected+4 ex vivo controls=8 paired samples. RNA was extracted from these samples, amplified, tagged and hybridized on Affymetrix Human Gene 1.0 ST microarrays according to standard operating procedures. Gene expression data were submitted to Gene Expression Omnibus (GEO; GSE60153, http://www.ncbi.nlm.nih.gov/geo/) and thus generated the “Human ex vivo infected” dataset (Table 5).

TABLE 5
Gene expression dataset description.

| | | Human ex vivo infected | Human in vivo infected |
|---|---|---|---|
| Dataset | | dataset | dataset |
| References | Authors | Gardeux V, Bosco A, et al. | ZaasA. K. et al. Cell Press |
| | Source | (present paper) | 2009 [5] |
| | (GEO) | Novel dataset (GSE60153) | GSE17156 |
| Platform | | Affymetrix GeneChip ® | Affymetrix Human Gene |
| | | Human Gene 1.0ST | U133A 2.0 |
| Probes measured | | 33297 | 22277 |
| Genes mapped to probes | | 19915 | 14288 |
| Human | Total | 4 | 9 |
| Subjects | subjects | | |
| (paired | Control | 4^{P} PBMCs incubated with | 9^{P} PBMCs collected 24 hrs |
| samples) | samples | control medium | prior to infection |
| | Infected | 4^{P} PBMCS incubated ex vivo | 9^{P} PBMCs collected at peak |
| | with | with virus | symptoms post intranasal |
| | rhinovirus | | virus inoculation (6 hrs-3 days) |

| | | |
|---|---|---|
| Viral infection experiment | Live human PBMC cells | Human subjects |
| | infected ex vivo & | inoculated in vivo intranasally |
| | incubated with Human | with Human |
| | Rhinovirus serotype 16 | Rhinovirus serotype 39 |
| | (ATCC ® VR-283) | (Charles River Lab; |
| | | Malvern, PA) |

^{P}Indicates paired samples derived from the same individual for rhinovirus-exposed with matched non-exposed PBMCs samples.

Dataset and Preprocessing.

Robust Multiple-array Average (RMA) normalization was applied on each patient data independently (2 paired samples at a time, to avoid bias in the single-patient experiments) using Affymetrix Power Tools (APT). We also used an external dataset downloaded from the GEO repository on Jul. 14, 2014 comprising a cohort of 20 healthy patients who were inoculated the rhinovirus. Blood samples were taken before inoculation and during the peak of symptoms on the disease. Among those 20 patients, 10 were defined as symptomatic and the other 10 as asymptomatic. We used the 9 microarray available paired data from the symptomatic patients and normalized them using the same RMA normalization technique. Table 5 recapitulates the content of each of those two datasets.

Genesets.

We aggregated genes into pathway-level mechanisms using the org.Hs.eg.db package (Homo Sapiens) of Bioconductor, available for R statistical software. We used two different genesets databases:
1) Gene Ontology (GO) Biological Processes (GO-BP). Hierarchical GO terms were retrieved using the org.Hs.egGO2ALLEGS database (downloaded on May 15, 2013), which contains a list of genes annotated to each GO term (geneset) along with all of its child nodes according to the hierarchical ontology structure.
2) KEGG pathways were retrieved using the org.Hs.egPATH database (download May 15, 2013).

Genesets included in the study comprised between 15 to 500 genes (among the genes measured by the microarray). This led to a total of 3234 GO-BP genesets and 205 KEGG pathway genesets. This filtering protocol follows the default one used in GSEA and a protocol we have previously identified as optimal for these studies.

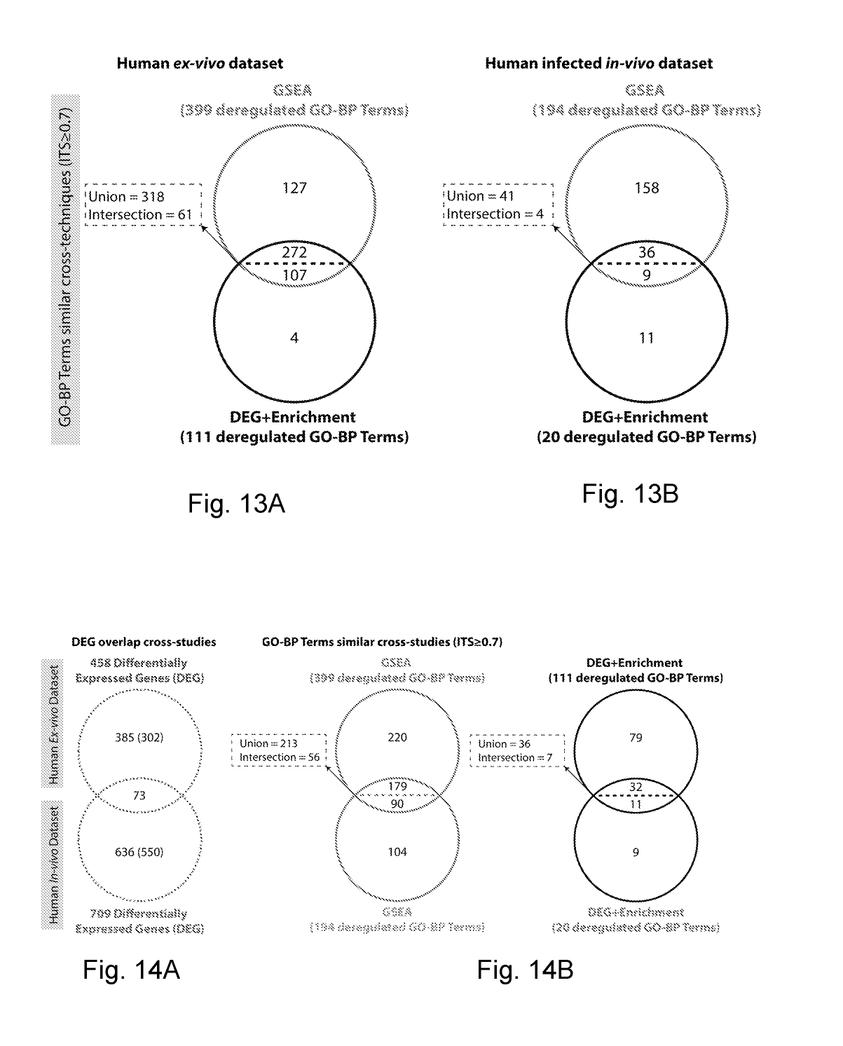

Gene Sets Enrichment Analysis (GSEA; FIGS. 13, 14, and 16).

Gene set enrichment analysis was conducted on both datasets. The GSEA v2.0.10 software was used with the default parameters except for the permutation parameter selection, which was set to “geneset” instead of “phenotype”. Geneset permutation was chosen to achieve enough statistical power for permutation resampling due to the small number of samples. Only deregulated GO-BP terms and KEGG pathways reaching the FDR≦5% significance threshold were retained for further analysis. It resulted in a list of 399 deregulated GO-BP terms between the non-exposed and rhinovirus-exposed samples for the ex vivo dataset, and 194 GO-BP terms and 11 KEGG pathways for the in vivo dataset.

Differentially Expressed Genes (DEG) Calculation (FIGS. 13A, 13B, 14A, 14B).

Differentially expressed genes (DEG) between non-exposed and rhinovirus-exposed samples were calculated using the SAMR package in R statistical software. Genes reaching the FDR≦5% threshold were considered significantly deregulated between the two conditions. Those protocols resulted in a list of 458 differentially expressed genes (DEG) found significantly deregulated in the ex vivo dataset and 709 DEG in the in vivo dataset.

DEG Enriched into GO-BP Terms (DEG+Enrichment; (FIGS. 13A, 13B, 14A, 14B).

Differentially expressed genes (DEG) were enriched into GO-BP terms using DAVID website. GO-BP terms reaching the FDR≦5% threshold were considered significantly enriched. It resulted in a list of 111 deregulated GO-BP terms between the non-exposed and rhinovirus-exposed samples for the ex vivo dataset, and 20 GO-BP terms for the in vivo dataset.

Information Theoretic Similarity (GO-ITS; FIGS. 13A, 13B, 14A, 14B, and 16).

We calculated the similarity between GO-BP terms using Jiang's information theoretic similarity that ranges from 0 (no similarity) to 1 (perfect match). We have previously shown that a GO-ITS score ≧0.7 robustly corresponds to highly similar GO terms using different computational biological validations: protein interaction, human genetics, and Genome-Wide Association Studies. ITS was calculated on each distinct pair among the 25363 GO terms, leading to 321,640,885 unordered pairs of which ^{˜}1.4 out of 1000 obtain scores of ≧0.7 ITS.

Novel Similarity Venn Diagram (FIGS. 13A, 13B, 14A, 14B) and Similarity Contingency Table.

In order to compare the different list of deregulated GO-BP terms, we computed uncommon Venn diagrams. Since every two GO-BP terms possess a measurable degree of similarity (see GO-ITS definition), it is possible to compare the two sets not only by direct overlap but also by degree of similarity. For each Similarity Venn diagram, we calculated the number of GO-BP terms similar to each of the two sets using a strong similarity GO-ITS threshold ≧0.7 (˜0.0014 pairs of all GO terms pairs meet this stringent criteria). This leads, for each Similarity Venn diagram, to two values in the intersection: the number of pathways (i) similar to the set B from the perspective of the set A, and (ii) vice-versa. If we take the intersection of those two sets, we obtain the traditional Venn diagram overlap, yet we can also compute their union. Of note, this technique may be extended to as many sets as needed. In order to calculate the statistical significance of the similarity of two sets of the Similarity Venn Diagram, we need the following two steps. First, we identify similar elements within pairs of the “unordered set of pairs of every combination from set A and set B” (abusively denoted “unordered A×B”). Second, we developed a Similarity Contingency Table in which conventional calculations of odds ratio and enrichment of similar pairs E unordered A×B can be calculated:

| | | NOT similar |
|---|---|---|
| | similar elements | elements within |
| | within pairs | pairs |
| Pair ε unordered A × B | | |
| Pair ∉ unordered A × B | | |

LEGEND:
ε “is an element of ”;
∉ “is not an element of”;
Background = total number of possible pairs (e.g. unordered GO-BP × GO-BP)

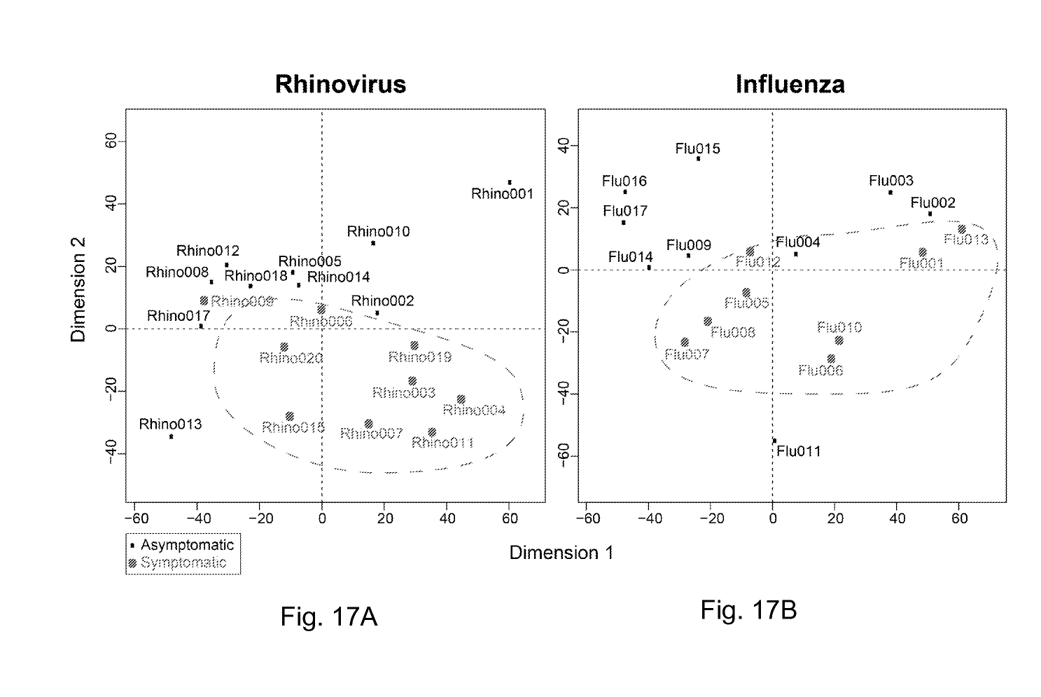

GO-Modules (FIG. 17).

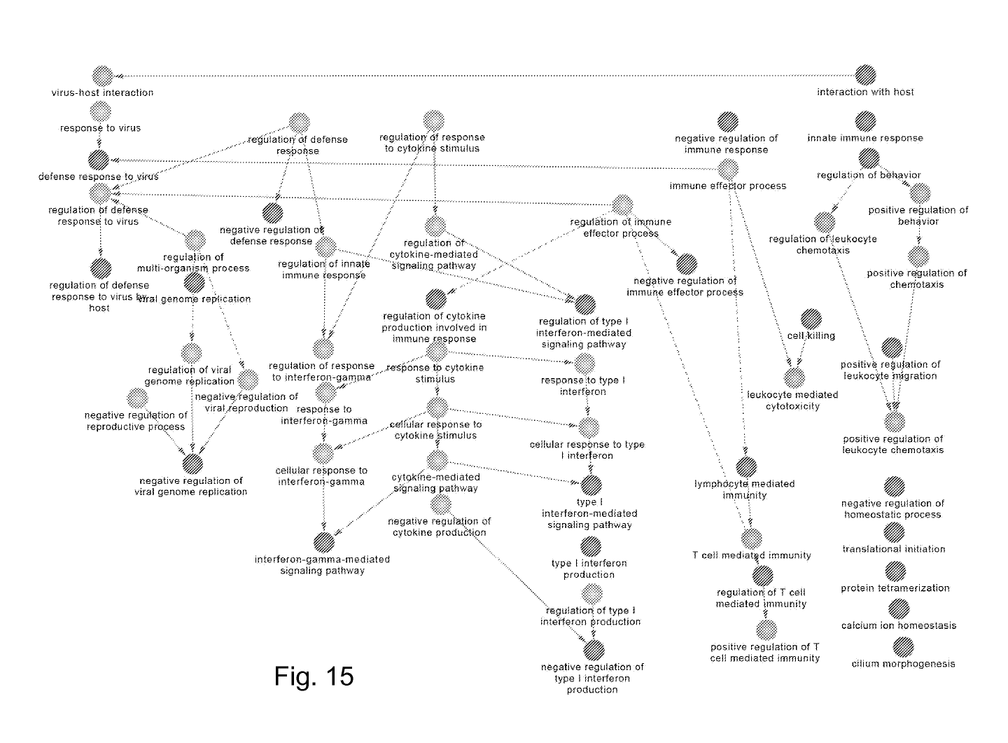

We previously developed GO-Module to synthesize and visualize enriched GO terms as a network. GO-Module reduces the complexity of nominal lists of GO results into compact modules organized in two distinct ways: by (i) constructing modules from significant GO terms based on hierarchical knowledge, and (ii) refining the GO terms in each module to distinguish the most significant terms (key terms of the module), subsumed terms to the Key term and terms of lesser importance (grey in FIG. 15).

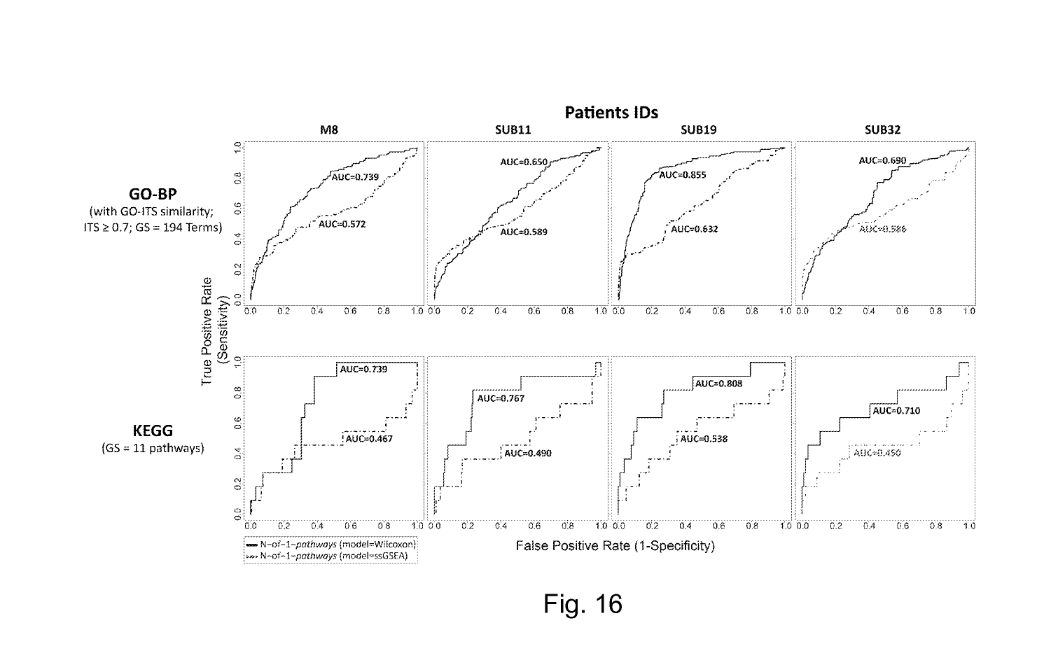

N-of-1-Pathways Framework (FIGS. 16 & 17).

N-of-1-pathways is a methodology unveiling deregulated pathways from only two paired samples. In this study, it was applied independently for each of the four patients, on the paired non-exposed and rhinovirus-exposed samples that we experimentally conducted for this paper. The N-of-1-pathways framework and software identifying the deregulated pathways (the scoring method) are modular and several different models can be substituted for the “pathway identification module”:

Wilcoxon Model.

The “Wilcoxon” statistical model was already validated on a retrospective lung adenocarcinoma survival prediction study and in vitro using both ovarian and breast cancer cell lines to identify an experimentally knocked down pathway. This model starts by restricting the gene expression data to the genes belonging to the considered gene set. Then it applies a Wilcoxon signed-rank test of the two restricted vectors of gene expressions to assess the deregulation of this gene set. Basically, this model recognizes gene sets having an over-representation of up-regulated genes compared to down-regulated genes, or vice versa. Two different methods were used to adjust p-values for multiple comparisons: Bonferroni (for a more stringent set of results) and Benjamini and Hochberg (False Discovery Rate; FDR). In each paired sample, only deregulated pathways with adjusted p-values following FDR≦5% or Bonf.≦5% were retained for further analysis.

Single-Sample GSEA or ssGSEA Model.

ssGSEA software is available from the GSEA portal (http://www.broadinstitute.org/gsea/index.jsp), and does not have a publication describing how its single sample method differs from the described cross-sample GSEA v2.0.10 software. Though without published evaluation (simulation or experimental) by the method's developers, ssGSEA was utilized on single-samples. We have previously extended the use of ssGSEA in the context of paired-samples within the N-of-1-pathways framework as an alternative to the Wilcoxon statistical model. In our implementation, we use the “ssGSEAPreranked” parameter and version that is applied on a pre-ranked list of genes and computes a permutation-based p-value for each gene set. Further, we pre-ranked the genes according to a metric derived from paired-samples: their fold-change between non-exposed and rhinovirus-exposed samples calculated separately for every patient.

Principal Component Analysis (PCA; FIG. 17).

The PCA was computed using the “FactoMineR” package in R (with default parameters). We first computed the matrix of p-values computed for each pathway of each individual patient. Then, these p-values were transformed into Z-scores using an inverse Standard Normal distribution (Z-score=abs(qnorm(p-value/2)) in R. The PCA was finally applied on this matrix of Z-scores.

Results

Comparison of Cohort-Based Results within the Ex Vivo and In Vivo Studies (FIGS. 13A & 13B).

We compared the concordance of results unveiled from cohort-based methods across four patients. We applied two well-established cohort-level methods: GSEA (Methods: GSEA) and DEG+Enrichment (Methods: DEG+Enrichment) on the four patients by comparing the four virus-exposed to the four non-exposed samples. In order to visualize their concordance, we plotted Similarity Venn Diagrams (Methods: Similarity Venn Diagram) between the results unveiled by GSEA and DEG+Enrichment (at FDR≦5%), separately within the ex vivo and the in vivo datasets. FIGS. 13A & 13B show the overlap as well as the similarity between the two techniques. The visible high overlap implies a robust signal linked to the virus response. In the center of the diagram are represented the number of pathways that are found significantly similar to the opposed list (by ITS cutoff ≧0.7; Methods: ITS), by taking each list as reference reciprocally.

FIG. 14. Concordance of Ex Vivo and In Vivo Human Studies.

Those Venn diagrams show the overlap and similarity of results unveiled across the two studies. FIG. 14A shows the overlap between the two lists of deregulated genes found using SAMR method (Methods: DEG calculation). Since the two studies used two different microarray chips, we showed in parenthesis the number of deregulated genes that can be found in the common background of both chips (common background=12819 genes). The overlap is very significant (Fisher's Exact Test p=3.41E-25; Odds Ratio=5.226. FIG. 134B shows the GO-BP terms that are overlapping or similar across both datasets by two different techniques: GSEA and DEG+Enrichment.

Comparison of the Individual Results to Cohort-Based Results Across the Ex Vivo and In Vivo Studies. (FIGS. 14A&14B & 15, Table 6).

After having established the concordance of results of the two cohort-level methods within each study, we aimed at comparing the two studies together. FIG. 14A shows a standard Venn diagram comparing the differentially expressed genes unveiled in each study (Methods: DEG calculation). It reveals a very strong overlap between the in vivo and ex vivo studies. FIG. 14B contains two Similarity Venn Diagrams, the green one representing the overlap and similarity between the GO-BP terms unveiled by GSEA across the two studies, and the purple one representing the same information, but when applying the DEG+Enrichment method. Globally, this Figure shows that we can recapitulate a lot of results from the ex vivo dataset compared to the in vivo study. The intersections of the two deregulated lists—whether differentially expressed genes or deregulated pathways—are very significant. In order to understand the biological relevancy of the GO-BP terms unveiled across the two studies (in vivo and ex vivo), we displayed the 56 GO-BP Terms found deregulated by the GSEA method as a network (FIG. 15). The connections between the GO-BP Terms are inferred from the ontology topology, which helps seeing the groups of terms interconnected. Table 6 recapitulates the 7 GO-BP terms found deregulated by the DEG+Enrichment method.

TABLE 6
Overlapping GO-BP Terms between ex vivo and in vivo studies
when DEG + Enrichment is applied. These terms correspond to
the overlap in the rightmost (purple) Similarity Venn Diagram
of FIG. 14 (right of Panel B).

| GO Term | Description |
|---|---|
| GO:0009615 | response to virus |
| GO:0006955 | immune response |
| GO:0007267 | cell-cell signaling |
| GO:0008285 | negative regulation of cell |
| GO:0009719 | response to endogenous stimulus |
| GO:0009725 | response to hormone stimulus |
| GO:0010033 | response to organic substance |

FIG. 15. Overlapping GO-BP Terms Between Ex Vivo and In Vivo Studies when GSEA is Applied Followed by GO-Module (Methods: GO-Module).

These terms correspond to the overlap in the left Similarity Venn Diagram in the center of FIG. 14B. The majority of the network shows a competent host innate immune response, with the subset of interferons I and Gamma among cytokines (center) and the cellular response of T-cells lymphocytes among leucocytes (right). The host-response to virus is shown in the hierarchies of the leftmost part of the network, and a few dissociated terms are left in the bottom right part.

Concordant Deregulated Pathways Unveiled Between Infected and Uninfected Samples (Table 7).

We applied the Wilcoxon model of the N-of-1-pathways framework for each patient's paired data between the control sample and the one subject to rhinovirus (Methods: N-of-1-pathways). The aim of this particular comparison was to identify the pathways deregulated ex vivo in presence of a virus, for each patient independently. Then, we aggregated the deregulated pathways obtained for each patient to identify the pathways commonly deregulated. Table 7 shows the whole list of GO-BP Terms and KEGG pathways (Methods: Genesets) found significantly deregulated across the four patients (Bonf.≦5%). The results are structured according to the ontology structure, for a better clarity. We can see pathways such as “response to virus” or “Cytosolic DNA-sensing pathway”, which are obviously biologically relevant regarding the studied phenotype. Taken together, those results show that: 1) the experimental protocol used is viable, and 2) the N-of-1-pathways methodology is able to uncover relevant pathways in this context. Moreover, we can see a certain “concordance” in the direction of deregulation unveiled in all those pathways. For example, the “response to virus” pathway is found up-regulated in the rhinovirus (RV) sample, i.e. the majority of the genes included in the pathway are up-regulated in the RV sample. In comparison, the KEGG pathways “Oxidative phosphorylation” and “Huntington's disease” are found down-regulated, and “Olfactory transduction” is the only pathway showing different “directions” between the four patients.

TABLE 7
GO-BP terms and KEGG pathways found deregulated
in all four patients' PBMC cells infected ex vivo,
using N-of-1-pathways analysis of the
dynamic transcriptome (Wilcoxon model; Bonf. ≦ 5%;
RMA Normalization). The “Size” column corresponds to
the number of genes in the geneset/pathway.

| Identifier | Decription | Size | Deregulation |
|---|---|---|---|
| GO:0009615 | response to virus | 247 | ↑ |
| | cytokine-mediated signaling | | ↑ |
| GO:0019221 | pathway | 341 | |
| GO:0045087 | innate immune response | 527 | ↑ |
| GO:0034340 | response to type I interferon | 73 | ↑ |
| ├ | | | ↑ |
| GO:0071357 | cellular response to type I interferon | 72 | |
| └ | type I interferon-mediated signaling | | ↑ |
| GO:0060337 | pathway | 72 | |
| hsa04623 | Cytosolic DNA-sensing pathway | 56 | ↑ |
| hsa00190 | Oxidative phosphorylation | 132 | ↓ |
| hsa04740 | Olfactory transduction | 388 | 2↓ 2↑ |
| hsa05016 | Huntington's disease | 183 | ↓ |

A Proxy Gold Standard Based on the In Vivo Data for Comparison at the Patient-Level (FIGS. 16 & 17).

Verifying experimentally all predicted pathways is rate-limiting and extremely expansive. Therefore, identifying a gold standard for studies generating dozens of GO terms and KEGG pathways is unrealistic. On the other hand, similarity to previously obtained results in comparable context allows for generating proxy gold standards. Since we aimed at finding if the N-of-1-pathways single-patient framework was able to uncover pathways significant in individual patients, we created a “proxy gold standard” using the list of deregulated pathways unveiled by GSEA in the in vivo dataset in order to obtain a global picture of the pathways we should find deregulated. We used FDR≦5% as a cutoff to fix the list of deregulated gene sets, which lead to 194 GO-BP term and 11 KEGG pathways in vivo. Then we ran the N-of-1-pathways framework on each patient of the ex vivo dataset and compared the results with this proxy Gold Standard. As a matter of comparison, we used both the Wilcoxon and the ssGSEA models. FIG. 16 shows the ROC curves corresponding to this comparison, each point being computed according to different nominal p-value cutoffs.

FIG. 16. Illustrates ROC Curves Showing the Robustness of N-of-1-Pathways Predictions in Each Ex Vivo Infected PBMC Confirmed by In Vivo Human Infection Study.

ROC curves are calculated by similarity to a Proxy Gold Standard (Methods). As measured by the Area Under the Curves (AUC), N-of-1-pathways' Wilcoxon Model outperforms the ssGSEA Model in every instance (one-tailed Wilcoxon matched paired signed rank test p=0.0039). As the theoretical random AUC is 0.5, we tested the significance of each models of N-of-1-pathways by pooling GO-BP and KEGG results: Wilcoxon Model p=0.004; ssGSEA Model p=ns (using the one-tailed Wilcoxon signed rank test).

In order to demonstrate the scalability of the method to other viruses and to show the individualized pathway scores could predict the clinical outcome (symptomatic vs asymptomatic infections), we included an additional study. We used more samples from the in vivo dataset than the 9 symptomatic patients. Indeed, the dataset also contains 10 patients that were exposed to the rhinovirus but remained asymptomatic. We ran the Wilcoxon model on those extra 10 patients and looked for differences in the individual representation of the deregulated pathways between the two groups. Of note, for those asymptomatic patients, the “exposed sample” was extracted after 72 hours of exposure, which corresponds to the median time for peak symptoms from symptomatic patient post inoculation. FIG. 17 shows a Principal Component Analysis that clearly clusters the two groups of patients without any supervision or pre-treatment of the N-of-1-pathways scores. This protocol was applied for the Rhinovirus as well as Influenza, which were both studied in the in vivo dataset. Of note, the ssGSEA model also clusters the data but the clusters are slightly less visible (data not shown).

FIG. 17A, 17B Illustrate a Principal Component Analysis of N-of-1-Pathways Scores Discriminates Asymptotic Patients from Symptomatic Infected Patients In Vivo (PBMC Expression).

The PCA analysis was conducted on the Z-scores matrix (Patients×GO-BP) produced by the Wilcoxon model within the N-of-1-pathways framework (Methods: PCA) in the context of two different virus exposures (Rhino=rhinovirus, 17A; Flu=Influenza, 17B). Each data point is a distinct patient for which all GO-BP Z-scores were presented to the PCA. In both PCA plots, we can see that the two first components cluster the symptomatic patients together. Of note, the PCA method is totally unsupervised, which suggests that N-of-1-pathways produces relevant p-values for each GO-BP terms.

Discussion

Overall, the biology is concordant ex vivo and in vivo, showing a high overlap and similarity of biologically relevant functions to viral infection. Indeed, FIG. 15 probably synthesizes best the biological results. Cytokines are broad categories of small proteins that are important in cell signaling. Among them, interferons are released by host cells in response of pathogens. Here, the ex vivo and in vivo studies corroborate in viral response specificity. Specifically, FIG. 15 shows that the cytokine regulation leads to only interferons Type I and Gamma (γ) to be deregulated. Type I interferons are well-studied molecules that play an essential role in viral functions, such as inducing direct anti-viral effects, as well as regulating innate and adaptive autoimmune systems. Interferon γ is crucial for immunity against viral infections and is produced rapidly by natural killer cells in viral infection and at a later stage by differentiation of T cells. Additionally, to the rightmost part of FIG. 15, the network shows a strong cellular innate immune response of leukocyte migration in response to chemotaxis signal, leucocyte mediated cytotoxicity. Among leukocytes, multiple GO terms specify T cell lymphocytes mediated immunity. Rhinoviruses infections being the most frequent cause of the common cold, it is not surprising that the in vivo study shows a response of T cells in the PBMCs as memory T cells from previously stimulated in previous rhinovirus infections may be re-activated by this infection and proliferate.

On the methodological aspect, we have again shown the N-of-1-pathways (Wilcoxon model) more accurate than the ssGSEA model, although the overall accuracy remains moderate. Future studies are required to test improved models. However, the lack of similarity of pathways deregulated on an individual level with a “consensus” proxy gold standard derived from 9 human subjects can also be explained by individual variation. Since we pioneered single subjects transcriptome analyses, very few studies report individual pathway variations. In our previous study in cancer, individual similarity to a gold standard varied considerably and a higher dissimilarity was significantly associated with poor patient survival. We had initially hypothesized this outcome as clonal cancer cell selection in response to therapy would likely favor cancer cell having more therapeutic escape mechanisms (in other words more deregulated). Additional studies comprising infected hosts symptoms would provide evidence to the reliability of the N-of-1-pathways framework to unveil individual subject mechanisms of resistance or sensitivity to infections.

We are aware that the current Wilcoxon model of the N-of-1-pathways framework may not be accurate in certain conditions. For example, if a batch effect is present between the two paired samples, we hypothesized that the Wilcoxon test may produce False Positives results (FPs), due to the shift of the mean. While conventional batch effect correction models could adjust FPs across several samples, the analytical innovation required is challenging when dealing with only two samples. Further studies involve designing new models for producing statistical significance of deregulated pathways with a mere two samples may circumvent this issue.

Conclusion

In this study, we showed that the transcriptomic of human ex vivo infection of rhinovirus could recapitulate the transcriptomic of human in vivo infection. The unveiled pathways are biologically meaningful and can be recapitulated by several well-established cohort-level methods. Moreover, this concordance can be found at a lower level, since we also found a strong overlap of differentially deregulated genes between the two conditions. Therefore, this raises the question of considering ex vivo studies when in vivo studies are either unethical and/or clinically unadvisable.

We also presented in this study an extended representation of classic Venn diagrams. We showed that those Similarity Venn Diagrams could display the simple overlap between two lists of terms, as well as their similarity. We believe that this kind of representation is scalable to any field comprising sets of terms from which a similarity metric can be obtained, such as BIG DATA results, Google™ queries, etc. Of particular interest are the suite of analytical packages applicable to the associated Similarity Contingency Tables we propose (e.g. odds ratio, enrichment studies, etc.).

Moreover, this study gave us the opportunity to validate—in the infectious context—the N-of-1-pathways framework that has the potential to inform on individually deregulated genesets. In conventional comparative study analyses, many samples of different human subjects are required for achieving sufficient statistical power to draw conclusions at the level of the studied population. The main interest is its applicability to single paired samples, without requiring a cohort as a background for reaching sufficient statistical power. As initially applied to normal vs tumoral samples, the framework was effective to analyze and discriminate between asymptomatic and symptomatic subjects exposed to viruses. As the genomic deregulation of these phenotypes is more subtle than those in cancer, these results underline the scalability of N-of-1-pathways to many clinical conditions such as before vs after treatment, or paired single cell studies, etc. It also provides a way of analyzing studies previously considered underpowered due to the scarcity of patients, as well as a strong framework for patient-centered precision medicine.

### Example 4

### Pathway Signature Built on an In Vivo Dataset Predicts Exacerbation in the Ex Vivo Study

Background.

We hypothesize that we could train a classifier with the mRNA expression patterns of the differences between unperturbed and rhinovirus perturbed peripheral mononuclear blood cells (PBMCs) of patients infected in vivo. The classifier was designed to discriminate between asymptomatic vs symptomatic patients. We further hypothesized that this classifier would identify asthmatic patients at risk of future hospitalizations.

Methods.

We used a previously published dataset of 19 patients inoculated with rhinovirus as a basis for building a predictor for our ex vivo phenotype of exacerbation (GSE17156; Zaas, A. K., et al., Gene expression signatures diagnose influenza and other symptomatic respiratory viral infections in humans. Cell Host Microbe, 2009. 6(3): p. 207-17). The in vivo dataset contains paired data for each patient at time of inoculation and after 72 hr of incubation, which corresponds to the peak symptoms. Further, the patients were annotated as “symptomatic” (9 patients) or “asymptomatic” (10 patients). We first ran the N-of-1-pathways framework to predict the personal pathway response to the rhinovirus for each of the 19 patients. The 19 lists of deregulated pathways were then transformed into a binary matrix by considering a pathway as deregulated if its nominal p-value was <5%. The classifier model was built on this in vivo binary matrix only (feature selection and model construction) to predict symptomatic vs asymptomatic patients, after chi square feature selection. Five classifier models were tested: Random Forest, Naïve Bayes, Decision Tree, Support Vector Machine (SVM), and Nearest Neighbor. Each model was then validated on the ex vivo dataset using the same binary transformation of the N-of-1-pathways results to predict future hospitalizations vs no future hospitalizations. The ex vivo dataset consisted of 23 patients followed for one year after extracting their PBMCs and were otherwise clinically comparable at baseline (11 non-hospitalized and 12 hospitalized). Their PBMCs were exposed ex vivo to rhinovirus and the mRNA extracted from paired samples before and after infection.

Results.

In table 7, the accuracies of all the classifiers are ˜70%. Globally, the best results were unveiled with 20 features (i.e. 20 Gene Ontology Biological Processes). Most importantly, the classifier was built for recognizing asymptomatic vs symptomatic patients in an in vivo study, but was found to be predictive of hospitalized status of patients in an ex vivo study.

TABLE 7
Performances of six different classifiers built on the in vivo
dataset and unbiasedly validated on the ex vivo dataset.

| | | Classification performance on Ex vivo dataset | | | | | | | | |
|---|---|---|---|---|---|---|---|---|---|---|
| Classifier | #Features | Accuracy | Sensitivity | Specificity | Precision | AUC | TP | FP | FN | TN |
| Random | 30 | 69.57 | 58.33 | 81.82 | 77.78 | 65.53 | 7 | 2 | 5 | 9 |
| Forest | 20 | 73.91 | 75 | 72.73 | 75 | 71.21 | 9 | 3 | 3 | 8 |
| Naïve Bayes | 20 | 73.91 | 75 | 72.73 | 75 | 67.42 | 9 | 3 | 3 | 8 |
| Decision | 20 | 65.22 | 75 | 54.54 | 64.28 | 64.77 | 9 | 5 | 3 | 6 |
| Tree | | | | | | | | | | |
| SVM | 25 | 73.91 | 75 | 72.73 | 75 | 73.86 | 9 | 3 | 3 | 8 |
| Near. | 20 | 69.57 | 66.67 | 72.73 | 72.73 | 69.70 | 8 | 3 | 4 | 8 |
| Neighbor | | | | | | | | | | |

Discussion.

It is worth noting that the classification protocol used was completely unbiased since the test set was only touched once, after the model was completely defined on the training dataset. We tried five different classification methods for assessing the robustness of the signal. Table 7 shows the resulting performances of those classifiers.

Conclusion.

We show the first evidence that an ex vivo viral assay can predict future hospitalization rate. N-of-1-pathways uses two genome-wide expression (pre infection and post-infection), the classifier is more accurate than the one obtained at the gene level only that failed to significantly classify the asthmatic patients. Of note, the ex vivo assay uses a classifier derived from an in vivo experiment.

We believe our technique can identify individuals at risk for asthma exacerbation. We believe our N-of-1 technique, as outlined in FIGS. 1 & 2, is capable of categorizing individuals genetically predisposed to mild disease versus those predisposed to severe disease for other viral, and viral-triggered, diseases also. Once individuals' predisposition to mild (such as asthma with few or no exaccerbations) versus severe (such as asthma with many exaccerbations) are identified, treatment plans can be adjusted to better trade off treatment side effects and disease symptoms.

### Combinations

The elements and methods herein described may be combined in multiple ways to provide an operational system. Among those various combinations of elements anticipated include:

A method designated A of predicting the course of progression of a disease and determining a personalized therapeutic regime for treating the disease in a subject in need of treatment for the disease including obtaining the subject's normal-tissue transcriptome; statistically correlating the subject's normal-tissue transcriptome with the subject's diseased-tissue transcriptome to identify one or more deregulated mechanisms; and using statistics derived from the identified deregulated mechanisms to predict the course of progression of the disease and a recommend a personalized therapeutic regime for treating the disease.

A method designated AA including the method designated A and further including statistically correlating the subject's normal-tissue and diseased-tissue transcriptome with corresponding transcriptome of one or more additional subjects.

A method designated AB including the method designated A or AA wherein the transcriptomes are measured by a method selected from RNA expression arrays and RNA-sequencing or any other methods measuring RNA expression

A method designated AC including the method designated A, AA, or AB wherein the disease is selected from neurodegenerative disease and cancer.

A method designated AD including the method designated AC wherein the disease is cancer.

A method designated AE including the method designated AD wherein the cancer is selected from lung cancer, breast cancer and ovarian cancer.

A method designated AF including the method designated AC wherein the disease is neurodegenerative disease.

A method designated AG including the method designated AF wherein the disease is Alzheimer's.

A method designated AH including the method designated AC wherein the disease is a viral disease.

A method designated AJ including the method designated AC wherein the disease is asthma and the perturbed culture is perturbed by infection with a rhinovirus.

A system designated B and adapted to evaluate a disease includes tissue sample or culture apparatus adapted to culture a normal culture and a perturbed culture of tissue, the tissue obtained from the patient. The system also includes RNA extraction and RNA characterization apparatus adapted to extract RNA from cell samples or cells grown in culture apparatus and to characterize the RNA expression level of extracted RNA by a method selected from an RNA probe microarray, aDNA microarray and an RNA sequencer, and a processor configured to receive the RNA expression levels from the RNA characterization apparatus, the processor having memory configured with machine readable code. The machine readable code includes code adapted to determine pathways associated with genesets of expressed RNA, and to exclude those unassociated with the pathways, to determine change of RNA expression level of the genesets between subject's normal and the perturbed sample; and to perform statistical analysis on the differences.

A system designated BA including the system designated B wherein the perturbed culture is a sample of cancerous cells from an organ or tissues of a patient and the normal culture is a sample of normal cells or uninvolved tissues from the same organ of the patient.

A system designated BAA including the system designated B wherein the perturbed culture is a cultured sample of normal tissue from the patient that has been infected with a virus ex vivo, and the normal culture is a cultured sample of normal tissue or cells.

A system designated BAB including the system designated BAA wherein the virus is a rhinovirus.

A system designated BB including the system designated B or BA wherein the RNA characterization apparatus comprises an RNA probe microarray and a microarray reader.

A system designated BC including the system designated B or BA wherein the RNA characterization apparatus comprises an RNA sequencer.

A system designated BD including the system designated B, BA, BB, or BC further comprising machine readable code for analyzing the statistics to provide a prognosis.

A system designated BE including the system designated B or BA further comprising a database of statistics versus patient outcomes, and wherein the machine readable code for analyzing the statistics to prove a prognosis uses the database of statistics versus patient outcomes.

It is understood that the foregoing description and accompanying examples are merely illustrative and are not to be taken as limitations upon the scope of the invention, which is defined solely by the appended claims and their equivalents.

1. A method of predicting the course of progression of a disease and determining a personalized therapeutic regime for treating the disease in a subject in need of treatment for the disease comprises:
obtaining the subject's normal-tissue transcriptome;
statistically correlating the subject's normal-tissue transcriptome with the subject's diseased-tissue transcriptome to identify one or more deregulated mechanisms; and
using statistics derived from the identified deregulated mechanism to predict the course of progression of the disease and a recommend a personalized therapeutic regime for treating the disease.

2. The method of claim 1 further comprising statistically correlating the subject's normal-tissue and diseased-tissue transcriptome with corresponding transcriptome of one or more additional subjects.

3. The method of claim 1 wherein the transcriptomes are measured by a method selected from RNA expression arrays and RNA-sequencing.

4. The method of claim 1, wherein the disease is selected from neurodegenerative disease and cancer.

5. The method of claim 4 wherein the cancer is selected from lung cancer, breast cancer and ovarian cancer.

6. The method of claim 4 wherein the neurodegenerative disease is Alzheimer's.

7. The method of claim 1, wherein the disease is a viral disease.

8. The method of claim 1, wherein the disease is asthma and the perturbed culture is perturbed by infection with a rhinovirus.

9. A system adapted to evaluate a disease comprising:
tissue culture apparatus adapted to culture a normal culture and a perturbed culture of tissue;
RNA extraction and RNA characterization apparatus adapted to extract RNA from tissue grown by the tissue culture apparatus and to characterize the RNA by a method selected from an RNA probe microarray, a DNA probe microarray, and an RNA sequencer;
A processor configured to receive the RNA characterization from the RNA characterization apparatus, the processor having memory configured with machine readable code to:
Determine pathways associated with genesets of expressed RNA according to the RNA characterization, and excluding RNA characterization unassociated with the pathways;
Determine differences in RNA expression levels between the normal and perturbed sample.

10. The system of claim 9 wherein the machine readable code that identifies pathways uses pathways identified in a gene annotation database selected from KEGG or GO.

11. The system of claim 9 wherein the perturbed culture is a sample of cancerous tissue from an organ of the patient and the normal culture is a sample of normal or uninvolved tissue from the same organ of the patient.

12. The system of claim 9 wherein the RNA characterization apparatus comprises an RNA probe microarray and a microarray reader.

13. The system of claim 9 wherein the RNA characterization apparatus comprises an RNA sequencer.

14. The system of claim 9, further comprising machine readable code for analyzing the statistics to provide a prognosis.

15. The system of claim 14 further comprising a database of statistics versus patient outcomes, and wherein the machine readable code for analyzing the statistics to prove a prognosis uses a database of statistics versus patient outcomes.

16. The system of claim 9 wherein the perturbed culture is a cultured sample of normal tissue from the patient that has been infected with a virus, and the normal culture is a cultured sample of normal tissue.

17. The system of claim 16 wherein the virus is a rhinovirus.

18. The system of claim 17 further comprising machine readable code configured to predict a patient's susceptibility to asthma exacerbations.
